(19) United States
(12) Patent Application Publication
(10) Pub. No.: US 2006/0122834 A1
(43) Pub. Date: Jun. 8, 2006

(54) Emotion detection device & method for use in distributed systems

(76) Inventor: Ian M. Bennett, Palo Alto, CA (US)

Correspondence Address: J. NICHOLAS GROSS, ATTORNEY, 2030 ADDISON ST., SUITE 610, BERKELEY, CA, 94704, US

(21) Appl. No.: 11/294,918

(22) Filed: Dec. 5, 2005

Related U.S. Application Data
(60) Provisional application No. 60/633,239, filed on Dec. 3, 2004.

(51) Int. Cl. G10L 15/14

(52) U.S. Cl. 704/256; 704/270.1

(57) ABSTRACT

A prosody analyzer enhances the interpretation of natural language utterances. The analyzer is distributed over a client/server architecture, so that the scope of emotion recognition processing tasks can be allocated on a dynamic basis based on processing resources, channel conditions, client loads etc. The partially processed prosodic data can be sent separately or combined with other speech data from the client device and streamed to a server for a real-time response. Training of the prosody analyzer with real world expected responses improves emotion modeling and the real-time identification of potential features such as emphasis, intent, attitude and semantic meaning in the speaker's utterances.

### RELATED APPLICATIONS

The present application claims priority to provisional application Ser. No. 60/633,239 filed Dec. 3, 2004 which is hereby incorporated by reference herein.

### FIELD OF THE INVENTION

The invention relates to a system and an interactive method for detecting and processing prosodic elements of speech based user inputs and queries presented over a distributed network such as the Internet or local intranet. The system has particular applicability to such applications as remote learning, e-commerce, technical e-support services, Internet searching, etc.

### BACKGROUND OF THE INVENTION

Emotion is an integral component of human speech and prosody is the principal way it is communicated. Prosody—the rhythmic and melodic qualities of speech that are used to convey emphasis, intent, attitude and semantic meaning, is a key component in the recovery of the speaker's communication and expression embedded in his or hers speech utterance. Detection of prosody and emotional content in speech is known in the art, and is discussed for example in the following representative references which are incorporated by reference herein: U.S. Pat. No. 6,173,260 to Slaney; U.S. Pat. No. 6,496,799 to Pickering; U.S. Pat. No. 6,873,953 to Lenning; U.S. Publication No. 2005/0060158 to Endo et al.; 2004/0148172 to Cohen et al; U.S. Publication No. 2002/0147581 to Shriberg et al.; and U.S. Publication No. 2005/0182625 to Azara et al. Training of emotion modelers is also known as set out for example in the following also incorporated by reference herein:
1. L. Breiman, J. H. Friedman, R. A. Olshen, and C. J. Stone. Classification and Regression Trees, Chapman & Hall, New York, 1984.
2. Schlosberg, H., A scale for the judgment of facial expressions, J of Experimental Psychology, 29, 1954, pages 497-510.
3. Plutchik, R., The Psychology and Biology of Emotion, Harper Collins, New York 1994.
4. Russell, J. A., How shall an Emotion be called, in R. Plutchik & H. Conte (editors), Circumplex Models of Personality and Emotion, Washington, APA, 1997.
5. Whissell, C., The Dictionary of Affect in Language, in R. Plutchik & H. Kellerman, Editors, Emotion: Theory, Research & Experience, Vol. 4, Academic Press, New York 1959.
6. ‘FEELTRACE’: An Instrument for Recording Perceived Emotion in Real Time, Ellen Douglas-Cowie, Roddy Cowie, Marc Schröder: Proceedings of the ISCA Workshop on Speech and Emotion: A Conceptual Framework for Research Pages 19-24, Textflow, Belfast, 2000.
7. Silverman, K., Beckman, M., Ostendorf, M., Wightman, C., Price, P., Pierrehumbert, J. & Hirschberg, J. (1992), A standard for labelling english prosody, in ‘Proceedings of the International Conference on Spoken Language Processing (ICSLP)’, Vol. 2, Banff, pp. 867-870.
8. Shriberg, E., Taylor, P., Bates, R., Stolcke, A., Ries, K., Jurafsky, D., Coccaro, N., Martin, R., Meteer, M.& Ess-Dykema, C. (1998), ‘Can prosody aid the automatic classification of dialog acts in conversational speech?’, Language and Speech 41(3-4), 439-487.
9. Grosz, B. & Hirshberg, J. (1992), Some intonational characteristics of discourse structure, in ‘Proceedings of the International Conference on Spoken Language Processing’, Banff, Canada, pp. 429-432.
10. Grosz, B. & Sidner, C. (1986), ‘Attention, intentions, and the structure of discourse’, Computational Linguistics 12, 175-204.
11 P. Boersma, D. Weenink, PRAAT, Doing Phonetics by Computer, Institute of Phonetic Sciences, University of Amsterdam, Netherlands, 2004, hhtp://www.praat.org
12. Taylor, P., R. Caley, A. W. Black and S. King, Chapter 10, Classification and Regression Trees, Edinburgh Speech Tools Libray, System Documentation, Edition 1.2, hxxp://festvox.org/docs/speech_tools-1.2.0/c16616.htm (replace xx with “tt”) Centre for Speech Technology, Univ. of Edinburgh, (2003)
13. Beckman, M. E. & G. Ayers Elam, (1997): Guidelines for ToBI labelling, version 3. The Ohio State University Research Foundation, hxxp://www.ling.ohio-state.edu/research/phonetics/E_ToBI/ (replace xx with “tt”)

Conversely, real-time speech and natural language recognition systems are also known in the art, as depicted in Applicant's prior patents, including U.S. Pat. No. 6,615,172 which is also incorporated by reference herein. Because of the significant benefits offered by prosodic elements in identifying a meaning of speech utterances (as well as other human input), it would be clearly desirable to integrate such features within the aforementioned Bennett et al. speech recognition/natural language processing architectures. Nonetheless to do this a prosodic analyzer must also operate in real-time and be distributable across a client/server architecture. Furthermore to improve performance, a prosodic analyzer should be trained/calibrated in advance.

### SUMMARY OF THE INVENTION

An object of the present invention, therefore, is to provide an improved system and method for overcoming the limitations of the prior art noted above;

A primary object of the present invention is to provide a prosody and emotion recognition system that is flexibly and optimally distributed across a client/platform computing architecture, so that improved accuracy, speed and uniformity can be achieved for a wide group of users;

Another object of the present invention, therefore, is to provide an improved system and method for formulating SQL queries that includes parameters based on user emotional content;

A further object of the present invention is to provide a speech and natural language recognition system that efficiently integrates a distributed prosody interpretation system with a natural language processing system, so that speech utterances can be quickly and accurately recognized based on literal content and user emotional state information;

A related object of the present invention is to provide an efficient mechanism for training a prosody analyzer so that the latter can operate in real-time.

A first aspect of the invention concerns a system and method for incorporating prosodic features while performing real-time speech recognition distributed across a client device and a server device. The SR process typically transfers speech data from an utterance to be recognized using a packet stream of extracted acoustic feature data including at least some cepstral coefficients. In a preferred embodiment this aspect of the invention extracts prosodic features from the utterance to generate extracted prosodic data; transfers the extracted prosodic data with the extracted acoustic feature data to the server device; and recognizes an emotion state of a speaker of the utterance based on at least the extracted prosodic data. In this manner operations associated with recognition of prosodic features in the utterance are also distributed across the client device and server device.

In other embodiments the operations are distributed across the client device and server device on a case-by-case basis. A parts-of-speech analyzer is also preferably included for identifying a first set of emotion cues based on evaluating a syntax structure of the utterance. In addition a preferred embodiment includes a real-time classifier for identifying the emotion state based on the first set of emotion cues and a second set of emotion cues derived from the extracted prosodic data.

In a system employing this aspect of the invention, the various operations/features can be implemented by one or more software routines executing on a processor (such as a microprocessor or DSP) or by dedicated hardware logic (i.e., such as an FPGA, an ASIC, PIA, etc.). A calibration routine can be stored and used on the client side or server side depending on the particular hardware and system configuration, performance requirements, etc.

The extracted prosodic features can be varied according to the particular application, and can include data values which are related to one or more acoustic measures including one of PITCH, DURATION & ENERGY. Correspondingly, the emotion state to be detected can be varied and can include for example at least one of STRESS & NON-STRESS; or CERTAINTY, UNCERTAINTY and/or DOUBT.

A further aspect concerns a system and method for performing real-time emotion detection which performs the following steps: extracting selected acoustic features of a speech utterance; extracting syntactic cues relating to an emotion state of a speaker of the speech utterance; and classifying inputs from the prosody analyzer and the parts-of-speech analyzer and processing the same to output an emotion cue data value corresponding to the emotion state.

Another aspect concerns a system/method training a real-time emotion detector which performs the following steps: presenting a series of questions to a first group of persons concerning a first topic (wherein the questions are configured to elicit a plurality of distinct emotion states from the first group of persons); recording a set of responses from the first group of persons to the series of questions; annotating the set of responses to include a corresponding emotion state; and training an emotion modeler based on the set of responses and corresponding emotion state annotations. In this fashion, an emotion modeler is adapted to be used in an emotion detector distributed between a client device and a server device.

In certain preferred embodiments visual cues are also used to elicit the distinct emotion states. The annotations can be derived from Kappa statistics associated with a second group of reviewers. The emotion modeler can be transferred in electronic form to a client device or a server device, where it can be used to determine an emotion state of a speaker of an utterance.

Still a further aspect of the invention concerns a real-time emotion detector which includes: a prosody analyzer configured to extract selected acoustic features of a speech utterance; a parts-of-speech analyzer configured to extract syntactic cues relating to an emotion state of a speaker of the speech utterance; a classifier configured to receive inputs from the prosody analyzer and the parts-of-speech analyzer and process the same to output an emotion cue data value corresponding to the emotion state. In this manner an emotion state is determined by evaluating both individual words and an entire sentence of words uttered by the user.

In preferred embodiments the classifier is a trained Classification and Regression Tree classifier, which is trained with data obtained during an off-line training phase. The classifier uses a history file containing data values for emotion cues derived from a sample population of test subjects and using a set of sample utterances common to content associated with the real-time recognition system. In the end emotion cue data value is in the form of a data variable suitable for inclusion within a SQL construct or some similar form of database query format.

Systems employing the present invention can also use the emotion state to formulate a response by an interactive agent in a real-time natural language processing system. These interactive agents are found online, as well as in advanced interactive voice response systems which communicate over conventional phone lines with assistance from voice browsers, VXML formatted documents, etc. The interactive agent may be programmed to respond appropriately and control dialog content and/or a dialog sequence with a user of a speech recognition system in response to the emotion state. For example, callers who are confused or express doubt may be routed to another dialog module, or to a live operator.

In some preferred embodiments an emotion state can be used to control visual feedback presented to a user of the real-time speech recognition system. Alternatively, in an application where display space is limited or non-existent, an emotion state can be used to control non-verbal audio feedback; for example, selection from potential “earcons” or hold music may be made in response to a detected emotion state.

In other preferred embodiments an amount of prosodic data to be transferred to the server device is determined on a case by case basis in accordance with one or more of the following parameters: a) computational capabilities of the respective devices; b) communications capability of a network coupling the respective devices; c) loading of the server device; d) a performance requirement of a speech recognition task associated with a user query. The both prosodic data and acoustic feature data may or may not be packaged within a common data stream as received at the server device, depending on the nature of the data, the content of the data streams, available bandwidth, prioritizations required, etc. Different payloads may be used for transporting prosodic data and acoustic feature data for speech recognition within their respective packets.

It will be understood from the Detailed Description that the inventions can be implemented in a multitude of different embodiments. Furthermore, it will be readily appreciated by skilled artisans that such different embodiments will likely include only one or more of the aforementioned objects of the present inventions. Thus, the absence of one or more of such characteristics in any particular embodiment should not be construed as limiting the scope of the present inventions. Furthermore, while the inventions are presented in the context of certain exemplary embodiments, it will be apparent to those skilled in the art that the present teachings could be used in any application where it would be desirable and useful to implement fast, accurate speech recognition, and/or to provide a human-like dialog capability to an intelligent system.

### BRIEF DESCRIPTION OF THE DRAWINGS

FIG. 1 is a block diagram of a preferred embodiment of an emotion analyzer distributed across a client/server computing architecture, and can be used as an interactive learning system, an e-commerce system, an e-support system, and the like;

FIG. 2 illustrates a preferred embodiment of an emotion modeler and classifier of the present invention;

FIG. 3 is a block diagram of a prior art natural language query system (NLQS);

FIG. 4 is a diagram illustrating an activation - evaluation relationship implemented in preferred embodiments of the present invention.

### DETAILED DESCRIPTION OF THE INVENTION

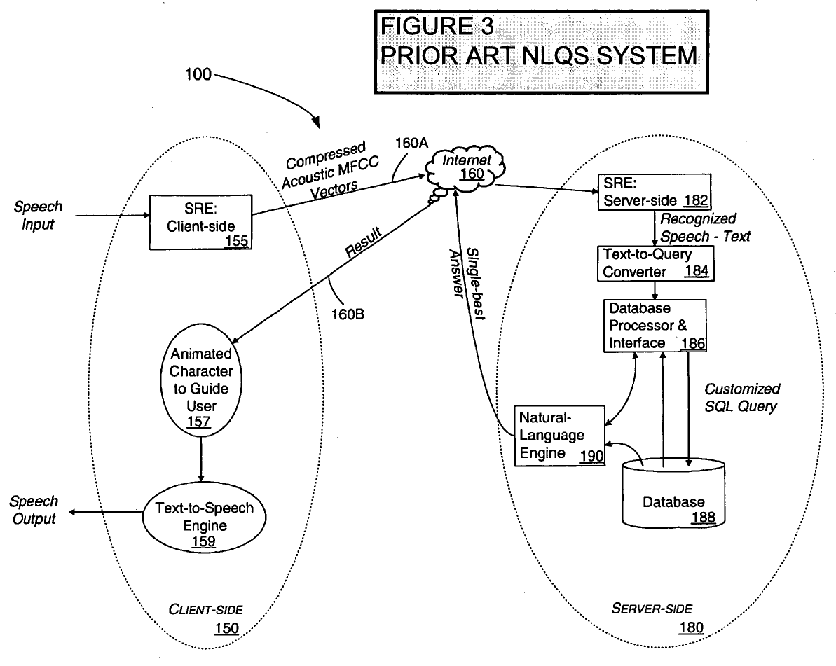

Brief Overview of Natural Language Query Systems As alluded to above, the present inventions are intended to be integrated as part of a Natural Language Query System (NLQS) such as that shown in FIG. 3 which is configured to interact on a real-time basis to give a human-like dialog capability/experience for e-commerce, e-support, and e-learning applications. As seen in FIG. 3 the processing for NLQS 100 is generally distributed across a client side system 150, a data link 160, and a server-side system 180. These components are well known in the art, and in a preferred embodiment include a personal computer system 150, an INTERNET connection 160A, 160B, and a larger scale computing system 180. It will be understood by those skilled in the art that these are merely exemplary components, and that the present invention is by no means limited to any particular implementation or combination of such systems. For example, client-side system 150 could also be implemented as a computer peripheral, a PDA, as part of a cell-phone, as part of an INTERNET-adapted appliance, an INTERNET linked kiosk, etc. Similarly, while an INTERNET connection is depicted for data link 160A, it is apparent that any channel that is suitable for carrying data between client system 150 and server system 180 will suffice, including a wireless link, an RF link, an IR link, a LAN, and the like. Finally, it will be further appreciated that server system 180 may be a single, large-scale system, or a collection of smaller systems interlinked to support a number of potential network users.

Initially speech input is provided in the form of a question or query articulated by the speaker at the client's machine or personal accessory as a speech utterance. This speech utterance is captured and partially processed by NLQS client-side software 155 resident in the client's machine. To facilitate and enhance the human-like aspects of the interaction, the question is presented in the presence of an animated character 157 visible to the user who assists the user as a personal information retriever/agent. The agent can also interact with the user using both visible text output on a monitor/display (not shown) and/or in audible form using a text to speech engine 159. The output of the partial processing done by SRE 155 is a set of speech vectors that are transmitted over communication channel 160 that links the user's machine or personal accessory to a server or servers via the INTERNET or a wireless gateway that is linked to the INTERNET as explained above.

At server 180, the partially processed speech signal data is handled by a server-side SRE 182, which then outputs recognized speech text corresponding to the user's question. Based on this user question related text, a text-to-query converter 184 formulates a suitable query that is used as input to a database processor 186. Based on the query, database processor 186 then locates and retrieves an appropriate answer using a customized SQL query from database 188. A Natural Language Engine 190 facilitates structuring the query to database 188. After a matching answer to the user's question is found, the former is transmitted in text form across data link 160B, where it is converted into speech by text to speech engine 159, and thus expressed as oral feedback by animated character agent 157.

Because the speech processing is broken up in this fashion, it is possible to achieve real-time, interactive, human-like dialog consisting of a large, controllable set of questions/answers. The assistance of the animated agent 157 further enhances the experience, making it mote natural and comfortable for even novice users. To make the speech recognition process more reliable, context-specific grammars and dictionaries are used, as well as natural language processing routines at NLE 190, to analyze user questions lexically. By optimizing the interaction and relationship of the SR engines 155 and 182, the NLP routines 190, and the dictionaries and grammars, an extremely fast and accurate match can be made, so that a unique and responsive answer can be provided to the user. For further details on the operation of FIG. 3, please see U.S. Pat. No. 6,615,172.

Overview of System for Real Time Emotion Detection

The present invention features and incorporates cooperation between the following components:
1. a data acquisition component which utilizes speech utterances from test subjects.
2. a prosodic extraction component for extracting prosodic related acoustic features in real-time preferably from speech utterances.
3. a comparator component which applies machine learning to the datasets—i.e. the dataset corresponding to the features extracted from the speech samples are fed to a decision tree-based machine learning algorithm.
4. Decision trees implemented using algorithms learned from the dataset effectuate the decision tree used in the real-time emotion detector.

The key focus of this approach is to use the acoustic features extracted from representative speech samples as the mechanism for identifying the prosodic cues in real-time from a speech utterance and which can then be used to detect emotion states. Other components may be included herein without deviating from the scope of the present invention.

An emotion modeler comprising the above implements the extraction of the speaker's emotion state, and uses the benefits from the optimization of the machine learning algorithms derived from the training session.

Emotion Detector

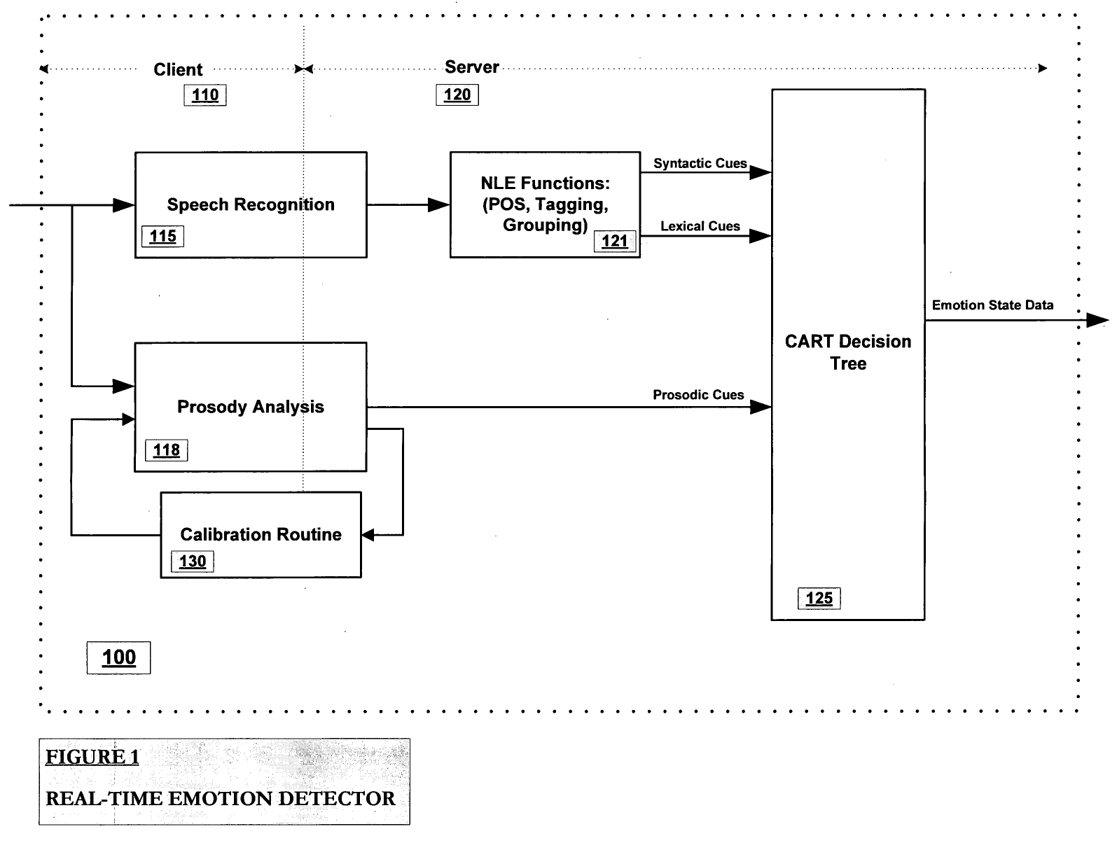

The function of emotion detector 100 (FIG. 1) is to model the emotion state of the speaker. This model is derived preferably using the acoustic and syntactic properties of the speech utterance. Emotion is an integral component of human speech and prosody is the principal way it is communicated. Prosody—the rhythmic and melodic qualities of speech that are used to convey emphasis, intent, attitude and semantic meaning, is a key component in the recovery of the speaker's communication and expression embedded in a speech utterance.

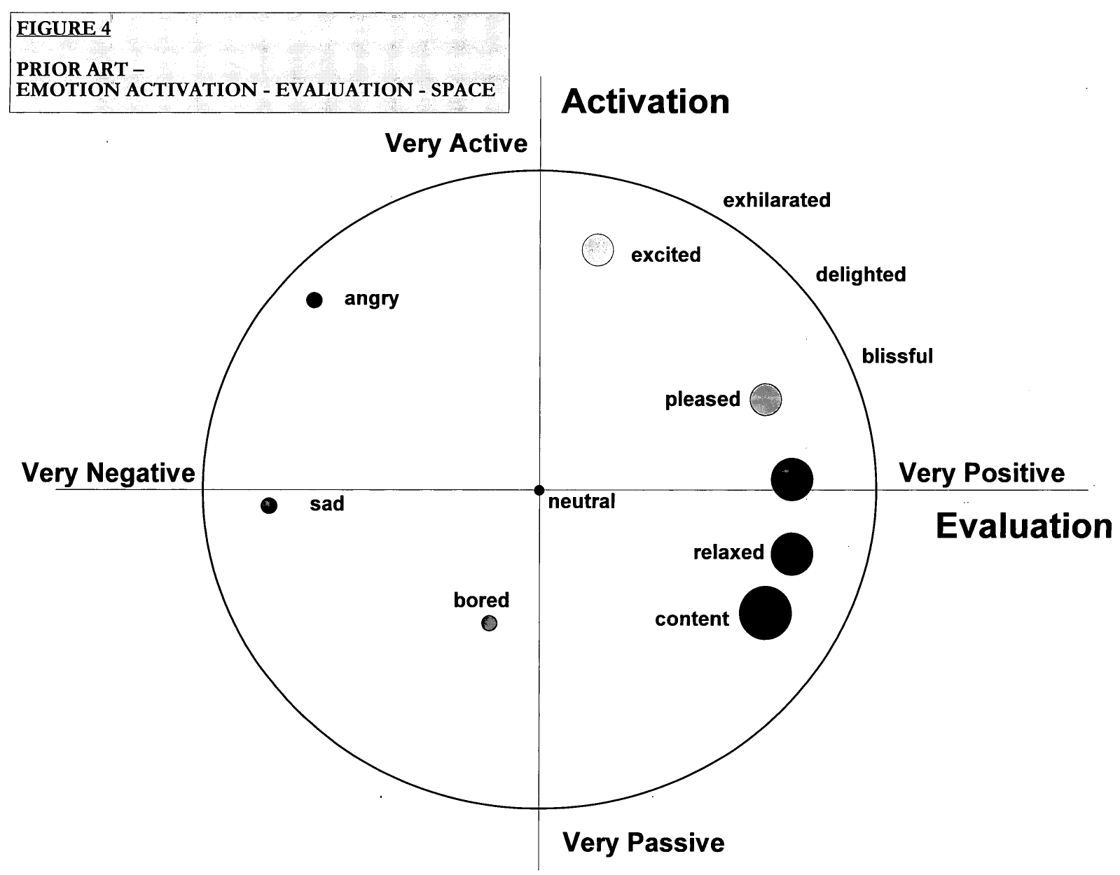

A key concept in emotion theory is the representation of emotion as a two-dimensional activation—evaluation space. As seen in FIG. 4, the activation of the emotion state—the vertical axis, represents the activity of the emotion state, e.g. exhilaration represents a high level of activation, whereas boredom involves a small amount of activation. The evaluation of the emotion state—the horizontal axis, represents the feeling associated with the emotional state. For example, happiness is a very positive, whereas despair is very negative. Psychologists [see references 1, 2, 3, 4, 5 above] have long used this two dimensional circle to represent emotion states. The circumference of the circle defines the extreme limits of emotion intensity such as bliss, and the center of the circle is defined as the neutral point. Strong emotions such as those with high activation and very positive evaluation are represented on the periphery of the circle. An example of a strong emotion is exhilaration, an emotional state which is associated with very positive evaluation and high activation. Common emotions such as bored, angry etc. are placed within the circle at activation-evaluation coordinates calculated from values derived from tables published by Whissell referenced above.

Representative Prosodic Features

Pitch—the fundamental frequency, FO of a speech utterance is the acoustic correlate of pitch. It is considered to be one of the most important attributes in expressing and detecting emotion. For this we extract FO and compute the mean, maximum, minimum and variance and standard deviation of FO. In some applications, of course, it may not be necessary or desirable to compute all such variables, and in other instances it may be useful to use additional frequency components (or derivatives thereof).

Energy—the energy of the speech utterance is an acoustic correlate of the loudness of the speech utterance of the speaker. For example, high energy in a speech utterance is associated with high activation of the emotion state. Conversely, low energy levels of the speech utterance are associated with emotion states with low activation values.

Duration—the duration of the syllables that make up the speech utterance also is a acoustic correlate from which an emotion cue can be extracted. For example, the long duration of a syllable, may infer an emotional state corresponding to doubt—DOUBT compared to alternate emotional state of certainty—CERTAINTY which in turn may be represented by a shorter time duration of the same syllable.

In some applications, of course, it may not be necessary or desirable to compute all such variables, and in other instances it may be useful to use additional frequency, energy and/or duration components (or derivatives thereof). For example in many cases it may be useful to incorporate certain acoustic features (such as MFCCs, Delta MFCCs) changes in energy, and other well-known prosodic related data.

Data Acquisition

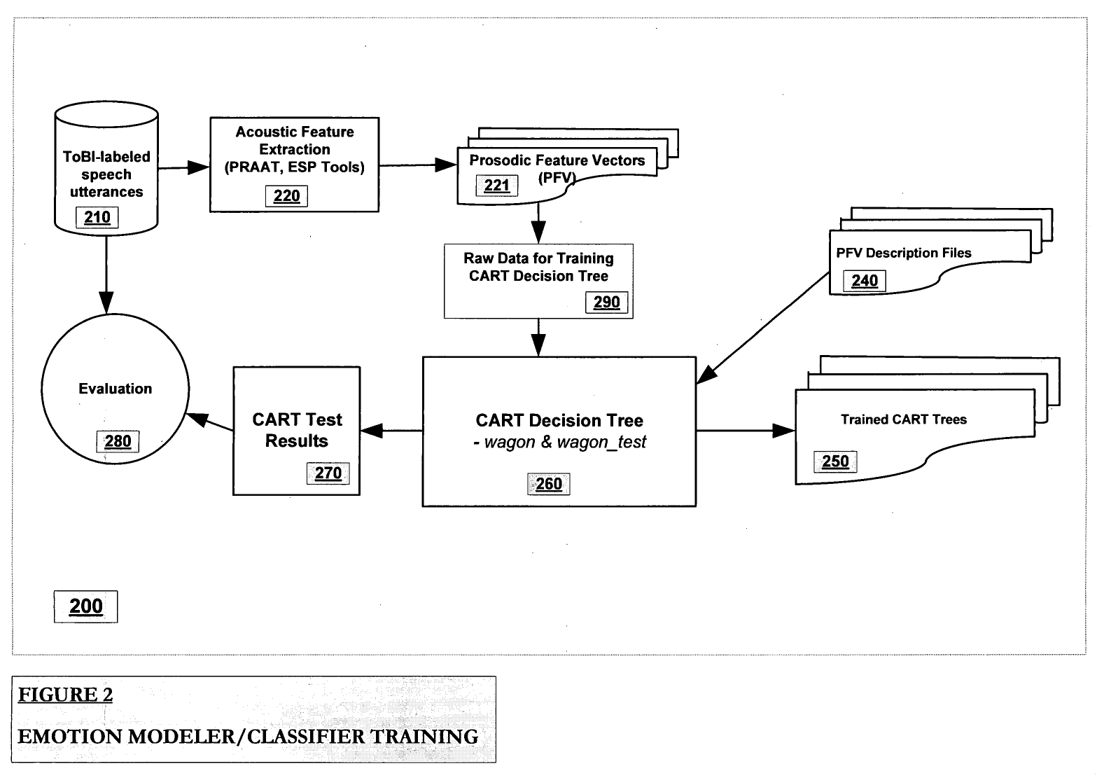

An emotion modeler and classifier system 200 of the present invention is shown in FIG. 2. This system is trained with actual examples from test subjects to improve performance. This training data is generated based on Prosodic Feature Vectors calculated by a routine 230.

To implement a training session, a data experiment is devised as follows: preferably a group of persons (i.e. in one preferred embodiment, students of a representative age comparable to the user group of students expected to use a natural language query system) is presented with a series of questions for which answers are to be articulated by the person. These questions are designed so that the expected elicited answers aided by visual cues exhibit emotions of CERTAINTY, UNCERTAINTY and DOUBT. For example, questions that have obvious answers typically will have a response that is closely correlated to the emotion state of CERTAINTY and can be ascribed to be present in more than 90% of the answers, whereas questions which are difficult will elicit answers from which the person is not sure of and therefore contain the UNCERTAINTY emotion also in greater than 90% of the cases. The formulation of the questions can be performed using any of a variety of known techniques.

Speech samples from these representative test subjects are recorded in a controlled environment—i.e. in a localized environment with low background noise. The speech as articulated by speakers speaking in different styles but with emphasis on the styles that represent the intended emotion modes that each sample requires. The recordings are preferably saved as .wav files and analysis performed using a speech tool such as the Sony Sound Forge and open source speech tools such as PRAAT [11] speech analyzer and the Edinburgh Speech Tools [12]. Other similar tools for achieving a similar result are clearly useable within the present invention. The analysis is discussed in the next section.

The recorded speech data is then played back and each sample is manually annotated preferably using Tone and Break Indices (ToBI) [13] annotation as illustrated in 210 (FIG. 2) using the definitions and criteria for specific emotional states. ToBI=Tone and Break Indices is a widely used annotation system for speech intonational analysis; again other annotation systems may be more appropriate for different applications.

By using the ToBI annotation, one is able to derive the intonational events in speech from the human perception of speech intonation. Kappa statistics are then used to evaluate the consistency between the annotators. Kappa Coefficients are well known: K=[P(A)−P(E)]/1−P(E) where P(A), observed agreement, represents the proportion of times the transcribers agree, and P(E), agreement expected by chance. Again any number of statistical approaches may be employed instead.

The emotion categories and criteria are as follows:

| Emotion | Description |
|---|---|
| CERTAINTY | No disfluencies; fluent answer; high energy |
| UNCERTAINTY | Disfluencies present; additional questions |
| | asked by the user re clarification - what is |
| | meant etc. |
| DOUBT | Slower response; heavily disfluent; lower |
| | energy |

The emotion states described in the table above can be extended to include other emotion states.

Feature Extraction

Acoustic features are extracted by a routine shown as 220. Before the initiation of the feature extraction process, the speech samples are preferably re-sampled at a 44 kHz sampling rate to ensure higher fidelity speech sample and higher quality source data for the speech feature extraction tools. The PRAAT speech analysis tool and the Edinburgh Speech Tools (EST) are the preferred tools used to extract the training session speech features. Using scripts the PRAAT tool automatically extracts and archives of a large number of speech and spectrographic features from each speech sample. The EST library also contains a number of speech analysis tools from which other speech features such as linear predictive coefficients (LPC), cepstrum coefficients, mel-frequency cepstrum coefficients (MFCC), area, energy and power can be extracted. Most importantly the EST library includes Wagon, a CART decision tree tool 260 which is used to extract prosodic patterns from the speech data.

Decision Tree Classifier Training

Decision tree classifiers, such as shown in FIG. 2, are probabilistic classifiers that transform data inputted to it into a binary question based on the attributes of the data that is supplied. At each node of the decision tree, the decision tree will select the best attribute and question to be asked about the attribute for that particular node. The selection is based on the particular attribute and question about it so that it gives the best predictive value for the classification or bin. When the tree reaches the leaf nodes, the probability about the distribution of all instances in the branch is calculated, which is then used as predictors for the new raw data. The selection of the node splitting is based on an information theory-based concept called entropy—a measure of how much information some data contains. In the decision tree, entropy can be measured by looking at the purity of the resulting subsets of a split. For example, if a subset contains only one class it is purest; conversely, the largest impurity is defined as when all classes are equally mixed in the subset. See e.g., Breiman et al.,1984 referenced above).

The CART decision tree algorithm 260 extends the decision tree method to handle numerical values and is particularly less susceptible to noisy or missing data. CART (Classification and Regression Tree) introduced by Breiman, Freidman, Olshen, Stone referenced above is a widely used decision tree-based procedure for data mining. The CART technique uses a combination of statistical learning and expert knowledge to construct binary decision trees, which are formulated as a set of yes-no questions about the features in the raw data. The best predictions based on the training data are stored in the leaf nodes of the CART.

During the training phase of the CART decision tree 260, data is fed to the tree from a Prosodic Description File 240 and training data from Prosodic Feature Vectors 230 and the values of key parameters such as stop value and balance are optimized so that the output results of the tree have maximum correspondence with the results of the manual annotations.

The specific and preferred CART used in the present invention is the Wagon CART of the Edinburgh Speech Tools library. Wagon CART consists of two separate applications—wagon for building the trees, and wagon_test for testing the decision trees with new data. Wagon supports two variables used in the tree-building process: a stop values for fine-tuning the tree to the training data set; the lower the value (i.e. the number of vectors in a node before considering a split), the more fine tuned and the larger the risk of an over-trained tree. If a low stop value is used, the over trained tree can be pruned using the hold out option, where a subset is removed from the training set and then used for pruning to build a smaller CART. The Wagon Cart requires a special structure of input—a prosodic feature vector (PFV)—i.e a vector that contains prosodic features in both predictor and predictees. Each row of this prosodic feature vector represents one predictee (a part of the PFV that has information about the class value, e.g. the accented class), and one or more predictors, each row having the same order of the predictors with the predictee as the first element in the row. The predictors are the values of the different prosodic cues that are selected. The size of the CART tree is optimized by means of the stopping criteria, which define the point when splitting of the nodes stops, i.e. when the purity of the node is highest. Another approach is to prune the tree—i.e. the tree is first grown out to a large size, then it is cut back or pruned to its best size. Other well-known approaches can also be used of course, and may vary from application to application. Referring to FIG. 2, the extracted acoustic features (as described in a following section Prosody Analysis, are extracted in 220. Then Prosodic Feature Vectors as described previously are formed in 221. The raw data, 290 for the Wagon CART is provided to the input of the Wagon CART. Then the output of the CART is sent to 250. The optimization of the CART tree output results is done in 280 by comparing the CART results 270 with the ToBI labeled speech utterances of 210. Once optimized, the trained CART trees are then outputted to 250 for later use.

Structure/Operation of Real-Time, Client Server Emotion Detector

The emotion detector 100 is integrated with the NLQS system of the prior art (FIG. 3). Specifically as shown in FIG. 1, the emotion detector is preferably implemented in distributed configuration in which some functions reside at a client 110, and other functions are at a server side 120. As noted above, a speech recognition process is also distributed, so that a portion of speech operations is performed by hardware/software routines 115. Like the NLQS distributed speech recognition process, a significant portion of the emotion modeling and detection is implemented at the client side by a prosody analyzer 118. Data values that are extracted at the client side are transmitted to the server for incorporation in the SQL construct for the database query process, or incorporated in higher level logic of the dialog manager. In this way the turn-taking and control of the dialogue is significantly shaped by the emotion states extracted from the speaker's utterance.

Accordingly emotion detector 100 as shown works in parallel with the speech recognition processes. It consists of three main sections:
1. A prosody analyzer 118 which operates based on extracted acoustic features of the utterance.
2. A parts-of-speech analyzer 121 which yields syntactic cues relating to the emotion state.
3. A trained classifier 125 that accepts inputs from the prosody analyzer 118 and the parts-of-speech analyzer and outputs data values which correspond to the emotion state embedded in the utterance.

The outputs of the prosody analyzer 118 and the parts-of-speech analyzer 121 are fed preferably to a trained CART classifier 125. This classifier 125 is trained with data obtained during the off-line training phase described previously. The data which populate the history file contained within the trained CART trees, 250 represent data values for the emotion cues derived from the sample population of test subjects and using the sample utterances common to the content in question. For example, in an educational application, the content would include tutoring materials; in other commercial applications the content will vary of course depending on the designs, objectives and nature of a vendor/operator's business.

Prosody Analysis

The prosody analysis as noted above is preferably based on three key acoustic features—Fundamental Frequency (FO), Amplitude (RMS) and Duration (DUR), extracted in real-time from the utterance. These features and derivatives of the features as described in Table 1 are used as inputs by the trained classifier 125. Again this is not intended to be an exhaustive list, and other prosodic parameters could be used in many applications. As in the initialization of the speech recognition process at the client side, there is an analogous calibration procedure used to calibrate the speech and silence components of the speaker's utterance. The user initially articulates a sentence that is displayed visually, and the calibration process 130 estimates the noise and other parameters required to find the silence and speech elements of future utterances.

Specifically, the calibration routine 130 uses a test utterance from which a baseline is computed for one or more acoustic features that are extracted by the prosody analysis block 118. For example, the test utterance includes a set of phrases, one of which contains significant stress or accent or other emotion indicator from which a large shift in the fundamental frequency (FO), or pitch can be calculated. Other acoustic correlates such as amplitude and duration can also be calculated. This test utterance, as in the analogous case of the signal-to-noise ratio calibration of speech recognition routines, allows the system to automatically compute a calibration baseline for the emotion detector/modeler while taking into account other environmental variables.

TABLE 1

| Acoustic | |
|---|---|
| Feature | Description |
| F0 | Fundamental frequency |
| F0_MAX | Maximum F0 |
| F0_MIN | Minimum F0 |
| F0_MEAN | Mean F0 |
| F0_RANGE | Difference between the highest F0 and lowest F0 |
| F0_STDV | Standard deviation in F0 |
| F0_ABOVE | Ratio of F0 100 ms from the median of F₀ |
| | compared to F₀ in the 100 ms range previous |
| RMS | Amplitude |
| RMS_MIN | Minimum amplitude |
| RMS_MAX | Maximum amplitude |
| RMS_RANGE | Difference between the highest and lowest |
| | amplitudes |
| RMS_STDV | Standard deviation from the amplitude mean |
| DUR | Duration - i.e. maximum time of word duration; |
| | The word duration is preferably normalized by |
| | the number of syllables contained in that word |
| DUR_MIN | Word duration minimum |
| DUR_MAX | Word duration maximum |
| DUR_MEAN | Word duration mean |
| DUR_STDV | Word duration standard deviation |
| (F₀_RANGE) × | Combination of above |
| (DUR) | |
| (F₀_RANGE) × | Combination of above |
| (RMS) × (DUR) | |

Parts of Speech (POS) Analysis

A NLQS system typically includes a parts-of-speech module 121 to extract parts-of-speech from the utterance. In the present invention this same speech module is also used in a prosodic analysis. Further processing results in tagging and grouping of the different parts-of-speech. In the present invention this same routine is extended to detect a syntactic structure at the beginning and the end of the utterance so as to identify the completeness and incompleteness of the utterance and/or any other out-of-grammar words that indicate emotion state such as DOUBT. For instance the sentences:

“This shape has a larger number of.”

“This shape has a larger number of sides than the slot.”

The previous sentence ending in ‘of’, is incomplete indicating DOUBT, whereas the second sentence is complete and indicates CERTAINTY. Other examples will be apparent from the present teachings. Thus this additional POS analysis can be used to supplement a prosodic analysis. Those skilled in the art will appreciate that other POS features may be exploited to further determine syntax structures correlative with emotion states. In this fashion an emotion state can be preferably determined by evaluating both individual words (from a prosodic/POS analysis) and an entire sentence of words uttered by the user (POS analysis).

Real-Time Classifier

The parts-of-speech analysis from routine(s) 121 yields syntactic elements from which emotion cues can be derived. The acoustic analyzer routine(s) 118 in turn yields separate data values for the prosodic acoustic correlates which are also related to emotion cues. These two categories of data are then inputted to a decision tree 125 where the patterns are extracted to estimate for the emotion state embedded in the of the speaker's utterance.

Again, the real-time classifier is preferably based on the Classification and Regression Tree (CART) procedure, a widely used decision tree-based approach for extracting and mining patterns from raw data. This procedure introduced by Breiman, Freidman, Olshen, Stone in 1984, is basically a flow chart or diagram that represents a classification system or model. The tree is structured as a sequence of simple questions, and the answers to these questions trace a path down the tree. The end point reached determines the classification or prediction made by the model.

In the end the emotion cue data value output from CART decision tree 125 can be in the form of a data variable suitable for inclusion within a SQL construct, such as illustrated in the aforementioned U.S. Pat. No. 6,165,172. The detected emotion state can also be used by an interactive agent to formulate a response, control dialog content and/or a dialog sequence, control visual feedback presented to a user, control non-verbal audio feedback such as selecting one or more audio recordings, etc., and as such are correlated/associated with different user emotion states.

In a distributed environment, the prosodic data is also preferably sent in a packet stream, which may or may not also include the extracted acoustic feature data for a speech recognition process, i.e., such as cepstral coefficients. Typically the prosodic data and acoustic feature data are packaged within a common data stream to be sent to the server, but it may be desirable to separate the two into different sessions depending on channel conditions and capabilities of a server. For example the latter may not include a prosody capability, and therefore emotion detection may need to be facilitated by a separate server device.

Moreover in some instances the prosodic data and acoustic feature data can be transmitted using different priorities. For example, if for a particular application prosodic data is more critical, than computations for prosodic data can be accelerated and a higher priority given to packets of such data in a distributed environment. In some instances because of the nature of the data communicated, it may be desirable to format a prosodic data packet with different payload than a corresponding speech recognition data packet (i.e., such as an MFCC packet sent via an RTP protocol for example). Other examples will be apparent to those skilled in the art. Furthermore the emotion detection/prosodic analysis operations can be distributed across the client device and server device on a case-by-case basis to achieve a real-time performance, and configured during an initialization procedure (i.e., such as within an MRCP type protocol). An amount of prosodic data to be transferred to said server device can be determined on a case-by-case basis in accordance with one or more of the following parameters: a) computational capabilities of the respective devices; b) communications capability of a network coupling the respective devices; c) loading of said server device; d) a performance requirement of a speech recognition task associated with a user.

The attached Appendix is taken from Applicant's provisional application referenced above.

### APPENDIX

Part 1: Identification and Significance of the Innovation

Introduction

This project will yield a computer-based spoken language training system that will begin to approximate the benefits provided by a one-on-one tutor-student session. This system will decrease the costs of tutoring as well as help compensate for the lack of human (tutor) resources in a broad set of educational settings.

If the next generation of computer-based training systems with spoken language interfaces is going to be successful, they must also provide a comfortable, satisfying and user-friendly environment. This project helps to approach the important goal of improving user experience so that the student experiences a satisfying, effective and enjoyable tutoring session comparable to that offered by one-on-one human tutors.

A successful training system will be able to tap into a large commercial training market as well as, adults with retraining needs that result from technology or process changes in the workplace, other employment dislocations or career changes, students with learning disabilities and remedial needs and students who are working on advanced topics beyond the scope of assistance available in their classroom.

It is widely accepted that students achieve large gains in learning when they receive good one-on-one human tutoring. [Cohen et al, 1982]. One of the success factors of human tutors is their ability to use prosodic information embedded in a students' unconstrained speech in order to draw inferences about the student's understanding of the lesson as it progresses, and to structure the tutor/student dialog accordingly. Current intelligent tutoring systems¹ are largely text-based, and thus lack the capability to use both semantic understanding and prosodic cues to fully interpret the spoken words contained in the student's dialog. Recently, researchers have demonstrated that spoken language interfaces, with semantic understanding, can be implemented with computer-based tutoring systems. Furthermore, the prosodic information contained in speech can be extracted automatically and used to assist the computer in guiding the tutoring dialog. Accordingly, enhanced dialog system capabilities, incorporating semantic and prosodic understanding, will here be designed and constructed to enable an intelligent tutoring system to simulate the responsive and efficient techniques associated with good one-on-one human tutoring and to thereby approach an optimal learning environment.
¹The mnemonic ITS is used in the literature to signify an Intelligent Tutoring System. In the context of this proposal, ITS is used to refer to our proposed system—an Interactive Training System. We also wish to clarify that training involves tutoring on a one-on-one basis or in a classroom setting.

What We Will Do

In the course of Phase I and Phase II the proposed research will focus on three key strategies to investigate the hypothesis that a pure text-based computer-based training can be improved to levels approaching the best one-on-one human tutors by:
Investigating how to extract conversational cues from a student's dialog using prosodic information, and apply data derived from these cues to the dialog manager to recognize misconceptions and clarify issues that the student has with the lesson.
Developing an architecture for Speaktomi's Spoken Language Interactive Training System that combines spoken language interfaces, and real-time prosody modeling together with a dialog manager implemented with cognitive reasoning agents. The spoken language interface is a stable, widely deployed speech recognition engine, designed and targeted for educational applications. Cognitive reasoning models implemented within cognitive reasoning agents will be used to create models of tutors that can be embedded in the interactive learning environment which will monitor and assess the student's performance, coach and guide the student as needed, and keep a record of what knowledge or skills the student has demonstrated and areas where there is need for improvement.
Testing the rudimentary system on previously developed corpora.
   Part 2: Background & Phase|Technical Objectives
   Background

The goal of computer-based tutoring environments has been to create an optimum educational tool which emulates the methods of good human tutors. One-on-one human tutoring has repeatedly been shown to be more effective than other types of instruction. An analysis of 65 independent evaluations indicated that one-on-one tutoring raised student's performance by 0.4 standard deviation units [Cohen et al, 1982]. Other studies report that the average student tutored by a ‘good’ one-on-one tutor scored 2.0 standard deviation units above average students receiving standard class instruction [Bloom, 1984]. Cognitive psychologists believe that important, “deep” learning occurs when students encounter obstacles and work around them, explaining to themselves what worked and what did not work, and how the new information fits in with what they already know [Chi et al, 1989; Chi et al, 1994; VanLeyn, 1990].

The challenge then for a computer-based tutoring system such as the one proposed is to emulate the desirable human one-on-one tutoring environment. Human one-on-one tutors interact with students via natural language—they prompt to construct knowledge, give explanations, and assess the student's understanding of the lesson. Most importantly, tutors give and receive additional linguistic cues during the lesson about how the dialogue is progressing. The cues received by the one-on-one tutor give the tutor information about the student's understanding of the material and allow the tutor to determine when a tutoring strategy is working or is not working. Natural language therefore is an important modality for the student/one-on-one tutor environment.

A further important requirement is that the system must not ignore signs of confusion or misconception as the presentation evolves. This means that the interactive training system, like its human counterpart, must detect and understand cues contained in the student's dialogue and be able to alter or tailor its response and its tutoring strategies. Published results on cognition and spoken dialog indicate that human tutors rely on subtle content present in the student's dialog to guide their participation in a meaningful, enjoyable and effective dialogue, thus augmenting the student's learning performance. Other researchers such as Tsukahara and Ward [Tsukahara & Ward, 2001; Ward & Tsukahara, 2003] have described systems which use the user's internal state such as feelings of confidence, confusion and pleasure—as expressed and inferred from the prosody² of the user's utterances and the context, and the use of this information to select the most appropriate acknowledgement form at each moment^{3.} Thus, in addition to the key challenge of correctly understanding the student's dialog—as transcribed by the speech-recognizer-based spoken language interface—the interactive training system in its goal of emulating a human tutor must identify the emotional states contained in the student's dialogue and apply it to the dialogue management in such a way that the specific task at hand—reinforcement of a concept, or spotting a misconception, or evaluation of progress—can be accomplished in real-time during the course of the dialog. This research proposal for an ITS is based in part on the assumptions regarding the acoustic-prosodic characteristics of speech and published results [Litman, Forbes-Riley, 2004; Shriberg, 1998; Rosalio et al, 1999] that emotion cues contained in the human speech can be extracted and applied in a data-driven manner to the dialog manager—the subsystem that controls the dialog between the student and system. This research proposal builds on the considerable work in the area of detecting emotion states in natural human-computer dialog. Silipo & Greenberg [Sillipo,Greenberg, 2000] found that amplitude and duration are the primary acoustic parameters associated with patterns of stress-related cues. More recently Litman [Litman, Forbes-Riley, 2004] reports that acoustic-prosodic and lexical features can be used to identify and predict student emotion in computer-human tutoring dialogs. They identify a simple two-way (emotion/non-emotion) and three-way classification schemes (negative/neutral/positive). Additionally, other researchers [Holzapfel et al, 2002] have also explored the use of emotions for dialog management strategies that assist in minimizing the misunderstanding of the user and thus improve user acceptance.
²The term prosody is generally used to refer to aspects of a sentence's pronunciation which are not described by the sequence of phones derived from the lexicon. It includes the whole class of variations in voice pitch and intensity that have linguistic functions.

³Ward and Tsukahara, “A Study in Responsiveness in Spoken Dialog”, International Journal of Human-Computer Studies, March 2003. Tsukahara and Ward, “Responding to Subtle, Fleeting Changes in the User's Internal State”, SIGCHI, March 2001, Seattle, Wash.

Vision and Research Goals

The vision that guides this research proposal is the goal of creating a spoken language interactive training system that mimics and captures the strategies of a one-on-one human tutor, because learning gains have been shown to be high for students tutored in this fashion. The dialog manager for the proposed interactive training system must therefore be designed to accommodate the unique requirements specific to the tutoring domain. This design stands in contrast to currently existing dialog management strategies for an information-type domain which have discourse plans that are either elaborate or based on form-filling or finite state machine approaches. The dialog manager for the proposed ITS must combine low-level responsive dialogue activities with its high level educational plan. Put another way, the dialog manager for our ITS must interweave high-level tutorial strategy with on-the-fly adaptive planning. The detection of emotion in the student's utterances is important for the tutorial domain because the detection of any negative emotion - such as confusion, boredom, irritation, intimidation, or conversely positive state such as confidence, enthusiasm in the student can allow the system to provide a more appropriate response, thus better emulating the human one-on-one tutor environment [Forbes-Riley, Litman, 2004].

For our proposed research we will use a speech corpus that contains emotion-related utterances such as the one available from the Oregon Graduate Institute The main thrust of this research proposal is the development of a spoken language interactive training system with a unified architecture which combines spoken language interfaces, real-time emotion detection, cognitive-based reasoning agents and a dialog manager. The architecture will be tailored for the special requirements of the tutoring domain with a dialog manager that enables smooth and robust conversational dialogs between the student and tutor, while allowing for better understanding of the student during the student-system dialog. What is new and innovative to this architecture is:

(1) prosody-based modeling of the student's dialog, and its use in managing the dialog so as to recognize misconceptions and clarify issues the student has with the lesson;

(2) the innovative use of multiple cognitive agents—each cognitive-based agent will be assigned a task or function such as assessing the student's performance, or creating a profile or characterization of the student before and after the lesson;

(3) the use of spoken language interfaces and the flexibility of the natural language modality that makes it possible to extract additional information contained in prosody of speech;

(4) an architecture that is tailored to the special requirements of the tutoring domain; and

(5) the incorporation of an application programming interface for compatibility with two widely deployed and popular software products used in the educational and multimedia market—Authorware and Director respectively, so as to accelerate adoption of the Speaktomi spoken language interactive training system in the targeted commercial market segment.

One of the overarching goals behind this research is embodied in our design approach which emphasizes the use of rapid and flexible prototyping natural language tools and environments such as the CARMEL⁴ language understanding framework and the Open Agent Architecture environment. The CARMEL framework, facilitates the rapid development of deep sentence-level language understanding interfaces required by the ITS without requiring that we address complex computational linguistic aspects, while being flexible enough to allow the developer to be involved in these issues. Similarly the OAA⁵ environment allows flexible and more rapid prototyping and debugging than alternate schemes. This proposal anticipates that the approach taken will save time and will allow us to focus on issues such as the ‘tutoring domain’-specific architectural issues, speech recognition imperfections and other key system integration issues.
⁴CARMEL=Core component for Assessing the Meaning of Explanatory Language is a language understanding framework for intelligent developed by the CIRCLE group—a joint center between Univ. of Pittsburgh and CMU and funded by the National Science Foundation.

⁵OAA=Open Agent Architecture is an open framework developed by the Stanford Research Institute for integrating the various components that comprise a software system such as the proposed spoken language ITS. Specifically it is a piece of middleware that supports C++, Java, Lisp and Prolog and enables one to rapidly prototype components into a system.

Challenges

One of the key challenges is in the speech transcription process—i.e. the transcription of speech to text by the speech recognizer is not ideal or error free, and speech recognition errors that result from using even the best speech recognizer will give rise to misunderstandings and non-understandings by the system, thus leading to non-robust and brittle performance. A key goal of the proposed research is to develop indicators of speech recognition errors that lead to these misunderstanding and non-understanding events, and to develop strategies for handling errors of this kind so that the resulting system performance is as robust as possible. We recognize this issue and the implementation of this component of the work will be done in Phase II.

Key Questions and Technical Objectives

The time required to develop a Version 1.0 of the commercially-ready spoken language ITS is projected to span Phase I and Phase II. In Phase I, exploratory work will confirm or not confirm the technical and commercial feasibility of the system by answering the first three key questions. The implementation of a solution to the fourth question will be deferred to Phase II.
1. How do we extract the acoustic-prosodic cues embedded in the utterances of a typical tutoring speech corpora?
2. What reference architecture can be defined for the interactive training system to make it suitable for the tutoring domain, and combines spoken language interfaces, real-time prosody modeler, dialog manager and cognitive-based reasoning agents?
3. What can be done or incorporated in the design of this ITS to accelerate the product adoption in the commercial market?
4. What is the road map or plan for detecting speech recognition transcription errors, and strategies to compensate for problems that arise from such speech recognition errors?
5.

Questions 1 will be answered fully and Question 2 partially by Objectives 1 and 2 below. The two technical objectives are:

Objective 1: To implement an algorithm for real time prosody modeling based on the prosodic characteristics of speech in order to extract and classify acoustic-prosodic characteristics contained in the student's speech.

We will develop techniques to model prosody characteristics from the corpus of a typical tutorial dialog. Speech, as a rich medium of communication, contains acoustic correlates such as pitch, duration, amplitude which are related to the speaker's emotion. The objective in Phase I will focus on developing techniques to extract such acoustic correlates related to two specific conditions—STRESS and NON-STRESS, to classify these conditions using machine learning algorithms with sufficient accuracy and then develop an algorithm for a real-time prosody modeling that can be implemented as a module of the ITS. The anticipated outcome of this objective will be a software algorithm which analyzes the student's dialog in real-time, and outputs data values corresponding to the prosody characteristics embedded in the student's speech. This algorithm will be extended in Phase II to cover additional emotion states and the data values used then in the operation of the dialog manager.

Obective 2: To implement the front end of the ITS comprised of the Speech Recognition, Natural Language and the real-time prosody modeling module (developed in Objective 1), so that the emotional state detection algorithm can be tested in a system setting. This algorithm extracts acoustic-prosodic cues from the speech corpora, and maps these to data-driven values representing emotional states.

The expected outcome of this objective at the end of Phase I is the prototype of the front-end of the proposed spoken language ITS architecture—i.e. the Speech Recognition, Emotion Detection and Natural Language modules. This front-end will be prototyped within the Open Agent Architecture (OAA) environment and will serve as an important step in proving the feasibility of interfacing the spoken language interface with real-time emotion detection and testing the algorithm developed in Objective 1. Additionally, these modules are important to the planned dialog management schemes for this tutoring domain. The dialog manager and other modules such as the text to speech synthesis agent and the speech error compensation strategies as well as questions 2 and 3 will be addressed in Phase II. In Phase II, Version 1.0 of the spoken language interactive training system will be completed. Additionally during Phase II, other tasks such as integrating an interface to the widely-used authoring tools, Authorware and Director, and testing the system using live subjects in real situations will be completed.

Part 3: Phase I Research Plan

Introduction

The spoken language interactive training system that we propose to build over the course of the SBIR Phase I and Phase II effort serves both a long term objective as well as the immediate Phase I project objective. The immediate objectives for this Phase I component of the project are to automatically identify, classify and map in real-time a number of acoustic-prosodic cues to emotional states embedded in a typical student's dialog. These data-driven values corresponding to these states will then be used to assist in formulating the dialog strategies for the ITS. The long term objective of the research is to build a spoken language-based ITS system that incorporates dialog control strategies that also incorporate emotional cues contained in the utterances of the student's dialogue. Another key long term objective is to develop and incorporate error-handling strategies into the dialog manager to compensate for speech recognition errors that occur within the speech recognition transcription process. This key objective ensures that the dialog remains robust, stable and stays on track so that the user experience is productive, engaging and enjoyable.

Specific Aims

In Phase I, we will pursue the following two key objectives: (1) development of an algorithm for real-time prosody modeling based on the acoustic-prosodic characteristics of speech; (2) implementation of the front-end of this spoken language ITS—i.e. the Speech Recognition, Natural Language and the real-time prosody modeler.

Background & Research Methodology

Overview of the Reference Architecture

The spoken language interactive training system uses traditional components required for implementing a spoken dialogue system. Spoken language systems are in general, complex frameworks involving the integration of several components such as speech recognition, speech synthesis, natural language understanding and dialog management as in an information retrieval application using spoken language interfaces. The representative functions of each component are:
Speech Recognizer (SR)—receives the acoustic signal from the user and generates a text string or other representation containing the utterances most likely to have been pronounced.
Natural Language Understanding—generates a particular natural language representation of the syntax and semantics of the text received from the speech recognizer.
Dialogue Manager (DM)—the core of the system—it controls the interaction with the user and coordinates other components.
Response Generator—produces the appropriate system replies using the information from the database.
Speech Synthesis—constructs the acoustic form of the system replies produced by the response generator.

The dialogue manager is the key component in dialog systems. Approaches such as Finite State Machines is not appropriate in an environment for dealing with unplanned events. FSM technology is usually found in limited domain environments. This DM must be an agent that monitors the execution of dialogue strategies and is able to change plans as unplanned events occur. In general, the dialog manager for a tutorial type domain must interweave high-level tutorial planning with adaptive on-the-fly plans. The environment for supporting such dialog management and control strategies must also be flexible enough to add agents that carry out tasks such as intention understanding and inference.

The AutoTutor (domain: computer literacy), CIRCSIM (domain: Newtonian mechanics) and the ATLAS-ANDES (domain: circulatory system) are representative examples of ITS that have been implemented. Each of these systems utilize DM models that implement a combination of different strategies: for example, AutoTutor's DM is an adaptation of the form-filling approach to tutorial dialogue. It relies on a curriculum script, a sequence of topic formats, each of which contains a main focal question and an ideal answer.

Speaktomi's proposed architecture for its spoken language ITS is based on a configuration of modular components functioning as software agents and adhering to the SRI Open Agent Architecture (OM)⁶ framework as shown in FIG. 1a. OM allows rapid and flexible integration of software agents in a prototyping development environment. Because these components can be coded in different languages, and run on different platforms, the OAA framework is an ideal environment for rapid software prototyping and facilitates ease in adding or removing software components. The term agent refers to a software process that meets the conventions of the OAA framework, where communication between each agent using the Interagent Communication Language (ICL) is via a solvable—a specific query that can be solved by special agents. Each application agent as shown can be interfaced to an existing legacy application such as a speech recognition engine or a library via a wrapper that calls a pre-existing application programming interface (API). Meta-agents assist the facilitator agent in coordinating their activities. The FacilitatorAgent is a specialized server that is responsible for coordinating agent communications and cooperative problem solving. OM agents employ ICL via solvables to perform queries, execute actions, exchange information, set triggers and manipulate data in the agent community.
⁶The SRI Open Agent Architecture (OAA) is a framework for integrating the various components that comprise a spoken dialogue system such as the FASTER ITS. Specifically it is a piece of middleware that supports C++, Java, Lisp and Prolog and enables one to rapidly prototype components into a system.

[image]

FIG. 1b shows a high-level view of specific software agents that comprise the speech-enabled ITS. Although each agent is connected to a central hub or Facilitator, there is a functional hierarchy which describes each agent and the flow of messages between them as shown in FIG. 3. This diagram illustrates the functional dependencies between the various blocks and the message interfaces between them.

The architecture will support the following software agents: user interface agents (microphone input and audio speaker output), the speech recognition agent, prosody modeler agent, natural language (NL) agent, dialog manager (DM) agent, synthesis agent, inference, history and knowledge base. This community of agents will be required for the full implementation of the ITS (Version 1.0) to be completed in Phase II.

The following paragraphs describe the brief background of each agent:

Objective 1: To Develop a Real-Time Algorithm that Builds a Dialog Prosody Model.

This objective has two goals:

1. To develop an algorithm for detecting prosodic structure of dialog in real-time & with sufficiently reliable performance for use in an interactive training system.

2. To assess the effectiveness of the selected acoustic features for prosodic cue detection. Because of the connection between learning and social interaction, we are motivated to enhance the capabilities and performance of the ITS by detecting interactional characteristics contained in speech in real-time, and then use data derived from the detected interactional dialog model to tailor the response of the system so that the system takes into account the student's interactional characteristics during the tutoring session.

Para-linguistic states including emotion, attention, motivation, interest level, degree of comprehension, degree of interactivity, and responsiveness are integral determinants of prosodic aspects of human speech, and prosody is the important mechanism through which the speaker's emotional and other states are expressed. Hence the prosodic information contained in speech is important if we want to ascertain these qualities in the speaker [cf. Shriberg, 1998]. Prosody is a general term for those aspects of speech that span groups of syllables [Par 86], and we incorporate in the concept dialog prosody: characteristics spanning not just one but multiple conversational turns. Prosody conveys information between the speaker and the listener on several layers. Prosodic features spanning several speech units that are larger than phonemes—i.e. syllables, words and turns—can be built up incrementally from characteristics of smaller units. Thus the prosody of phrases incorporates the characteristics of the syllables that make it up; the linguistic stress levels of the syllables, their syllable-length melodic characteristics, can be combined to form phrase-level prosodic structures, similarly smaller phrases can be combined to form utterance-level models, and utterance sequences along with timing and other relationships between turns are combined into a dialog level prosodic model. We will proceed incrementally from bottom up in this work, keeping in mind the higher level modeling structures which are to be developed. The first level of post-speech-recognition modeling, which is our objective in this Phase I proposal, incorporates syllabification or grouping of phones into syllables, syllable-level pitch contour characterization, and syllable stress level classification. For this objective, in addition to dictionary entries for syllabification and lexical stress levels we will measure the three key speech signal acoustic features—pitch, duration and energy. Duration of segments, syllables, and phrases, fundamental frequency—Fₒ—the acoustic correlate of pitch, and to a lesser degree, energy or amplitude, the correlate of loudness, are the observational basis of prosody in human speech. The variation of pitch over a sentence, also called intonation, is used in spoken language to shape sentences and give additional meaning or emotion to the verbal message during human communication [Mom02, Abe 01]. Simplifying for analytic purposes, pitch in English can be defined at four levels—low, mid, high or extra high; and having three terminal contours—fading, rising, or sustained. Fundamental frequency measurements will be used to characterize syllable or sub-syllable level pitch contours with this vocabulary. These characterizations along with the other acoustic measures of amplitude and duration, along with pitch range, will be used to classify syllables by phrasal stress levels. To facilitate the successful outcome of the objective, the research will be broken out into the following four key sections:
1. Preparation of the corpus.
2. Extraction of the acoustic correlates from which prosodic cues can be derived.
3. Classification of the acoustic correlates using machine learning algorithms & verification with the manually annotated corpus.
4. Development of the real-time prosodic modeling algorithm.
   The desired outcome for this research objective is an algorithm implemented in software that extracts, classifies and verifies in real-time the prosodic structure contained in the spoken dialog. What follows is a description of the research methodology for each of the above sections.
   Preparation of the Corpus

Before the extraction can begin, we will acquire a speech corpus in the form of a database or a corpus containing a set of files from one of several recognized linguistic repositories⁷. The corpus sourced from the Oregon Graduate Institute is supplied with a phonetic transcription file with each speech file. If the sourced files are not annotated, the files will be manually marked or linguistically annotated⁸ in terms of prosodic stress by a pair of linguistically trained individuals. In order to provide more robustness for the experimental task, each of two subsets of files will be annotated by a manual transcriber. In addition, we will use a Jack-knifing training and testing procedure. With this procedure, two thirds of the files used as the training set and one third of the files used as the test set will be cyclically exchanged so that three different pairs of training and test sets are created for the entire research measurements. Before going to the next step we will compare the annotations made by each transcriber to ascertain the agreement between the two transcribers in annotating the files that are common to each of the two subsets of files. We will initially aim to annotate syllables into two categories—STRESS and UNSTRESSED⁹. Once we develop and confirm experimental procedures for classifying these two levels, we can proceed to prosodic modeling of larger units. At the level of turn-taking our experimental procedures will be provide information that would enable a tutoring system to infer paralinguistic characteristics of the dialog participants. The possibility is raised of emotion classification as in the work of Litman [Litman et al, 2004]—for example, Positive (confident, enthusiastic); Negative (confused, bored, uncertain) and Neutral (neither Positive or Negative).
⁷Linguistic Data Consortium, Univ. of Pennsylvania; Oregon Graduate Institute (OGI); and the Berkeley International Computer Science Institute (ICSI).

⁸ToBI—tone and break indices—is a method used in linguistics to annotate English utterances with intonation patterns & other aspects of the prosody.

⁹Although many levels of prosodic stress are claimed to exist by some phonologists, at most three levels of stress can be detected in speech recordings by trained linguists with even moderate reliability—primary stress, absence of stress and weak stress. To achieve good reliability, at most two levels can be used [Veatch 1991].

The KAPPA Coefficient K¹⁰ will be used as the metric that measures the pair wise agreement between the two transcribers. This metric represents the ratio of the proportion of times that the transcribers agreed to the maximum proportion of times that the transcribers could have agreed. Using the criteria established by Carletta [1996], Kappa values greater than 0.8 imply good reproducibility, while those within the range of 0.67-0.8 imply that firm conclusions cannot be made regarding the labeling agreement between the transcribers.
¹⁰Kappa Coefficient, K=[P(A)−P(E)]/1−P(E) where P(A), observed agreement, represents the proportion of times the transcribers agree, and P(E), agreement expected by chance.

Extraction of Acoustic Features

In addition to the segmentally time-stamped transcript of the dialog provided with the corpus or provided in live usage by the speech recognizer, we will extract the following primary acoustic features—pitch, duration and energy. For this latter purpose we will use the PRAAT¹¹ software, a widely available and accurate speech analysis tool to extract the following measures for each syllabic unit:
¹¹PRAAT web page: http://www.praat.org. The PRAAT speech analysis tool incorporates an accurate fundamental frequency algorithm developed by Professor Boersma of the University of Amsterdam, Holland.

1. Pitch frequency and related correlates: F₀¹²-maximum (F_{0—}MAX), minimum (F_{0—}MIN), mean (F_{0—}MEAN) & standard deviation (F_{0—}STDV), difference between highest and lowest (F_{0—}RANGE), ratio of those above center of F₀ range to those below the center (F_{0—}ABOVE).
   ¹²F0=fundamental frequency also called pitch, is the periodicity of voiced speech reflecting the rate of vibration of the vocal folds.
2. Duration and related correlates: duration (DUR), maximum duration (DUR_MAX), minimum duration (DUR_MIN), mean duration (DUR_MEAN), standard deviation from duration mean (DUR_STDV).
3. Amplitude and related correlates: Amplitude (RMS), Minimum amplitude (RMS_MIN), Maximum amplitude (RMS_MAX), mean amplitude (RMS_MEAN), difference between the highest and lowest amplitudes (RMS_RANGE), standard deviation from amplitude mean (RMS_STDV).

Combinations of the above primary features such as [F_{0—}RANGE×DUR] or [F_{0—}RANGE×RMS×DUR] will be calculated and used in the analysis.

Classification of Acoustic Features for Prosodic Modeling

After the above acoustic features are extracted for each syllable in each voice file in each subset, we will employ machine learning algorithms to classify the acoustic data and map acoustic correlates to the prosodic structure, specifically stress levels. The main goal of this part of the experiment is in using machine learning algorithms to automatically determine which acoustic-prosodic features are the most informative in identifying and mapping the two stress levels from these features. Machine learning has been established to be a valuable tool for data exploration for a number of data classification problems in fields such as linguistics. Some of these schemes [Witten & Frank, Data Mining, Morgan Kaufmann, 2000] are more efficient or better with certain types of data than others, and some are more suited for classifying certain data distributions that have many subtle features. Since we do not know the structure of the data and the relevance or irrelevance of some of the features, it behooves us to attempt to classify the extracted data with more than a few learning schemes. We will use a representative number of these data-driven algorithms such as boosting (AdaBoost), classification and regression trees (CART), artificial neural networks (ANN), support vector machines (SVM) and nearest neighbor methods. For each machine learning algorithm such as the ANN, there will be a training phase for example—the input vector will consist of four parameters—duration, amplitude, average pitch and pitch range, and the output will consist of two normal units—one for STRESS and the other for UNSTRESSED. After the network is trained, the acoustic measurements from the test files contained in one third of the subset will be inputted to the ANN. The implementation of the machine learning classifier-based experiments will be performed within the WEKA¹³ machine learning software environment and with the Stuttgart Neural Network Simulator (SNNS)¹⁴. All of the software that will be used in this objective—PRAAT, WEKA and SNNS is already installed and working on our workstations. The WEKA environment is a flexible environment—it provides the capability to do cross validation and comparisons between the various machine learning schemes—for example, we will be able to compare the classifications generated of each machine learning algorithm such as K-Nearest Neighbors, AdaBoost, CART decision trees, and the rule-based RIPPER (Repeated Incremental Pruning to Produce Error Reduction) and to generate optimum parameters for the real-time prosodic modeling algorithm based on acoustic feature importance, acoustic feature usage and accuracy rate. In this way we will assess which classification scheme most accurately predicts the prosodic models. Confusion matrices will then be used to represent and compare the recognition accuracy as a percentage of stress levels and the two-way classifications generated by the different classifiers.
¹³WEKA software—a public domain and widely used data mining and machine learning software available from the University of Waikato, New Zealand, http://www.cs.waikato.ac.nz/ml/

¹⁴SNNS software: http://www-ra.informatik.uni-tuebingen.de/SNNS/

Development of the Real-Time Prosodic Modeling Algorithm

At this point in the analysis, we will discover by experiment which combination of acoustic features—amplitude, pitch, pitch range or others derived from the base set, will most accurately classify syllables into STRESS or NON-STRESS categories. Specifically, we will develop an algorithm based on the combination of measured acoustic features such as amplitude, average pitch, pitch range, duration. As shown in FIG. 1, the result is an evidence variable that represents the combination of the above correlates that leads to a local maximum for stress level classification accuracy. Additionally, receiver operator characteristic curves will be plotted using the key acoustic parameters to ascertain which acoustic parameter or combination of parameters play the dominant role in recognizing the stress level. We will also use this evidence variable, combining acoustic features to formulate an algorithm from which the prosodic structure can be detected in real-time.

Objective 2: To Implement the Front End of the Spoken Language ITS (Comprised of the Speech Recognition, Natural Language and the Prosody Modeler (Developed in Objective 1) Using the Rapid Prototyping Open Agent Architecture (OAA) Environment.

The expected outcome of this objective at the end of Phase I is a prototype of the front-end of the ITS architecture defined in Objective 2—i.e. the speech recognition, natural language and prosody modeler modules as shown in FIG. 3. A second task will be to prepare a road-map and plan for Phase II.

[image]

The integration of this front-end of the system will serve as an important step in proving the feasibility of interfacing the spoken language interface with real-time emotion detection and would be critical to the strategy for the dialog management for this tutoring domain.

Speaktomi will implement the front end of the speech-based ITS within the reference architecture discussed previously and based on a configuration of modular components functioning as software agents that adhere to a software framework called the Open Agent Architecture (OAA)¹⁵.
¹⁵The SRI Open Agent Architecture (OAA) is a framework for integrating the various components that comprise a spoken dialogue system such as the FASTER ITS. Specifically it is a piece of middleware that supports C++, Java, Lisp and Prolog and enables one to rapidly prototype components into a system.

Research Plan: The front end for the ITS will be implemented by creating software agents for each of the Speech Recognition, Emotion Detector and Natural Language software modules. We will employ the SRI Eduspeak engine as the speech recognition module. The emotion detector will be the software application as described under Objective 1. For the Natural Language module we will use the CARMEL Workbench for language understanding.

Speech Recognition Agent

The OAA-based speech recognition agent will be created by writing a software wrapper for the SRI EduSpeak speech recognition engine. This engine incorporates specific features required for education and tutoring applications such pronunciation grading and a broad array of interfaces to multimedia development tools and languages—Director, Authorware, Flash, Active X, Java and C/C++. The EduSpeak SR engine works for adult and child voices as well as native and non-native speakers. The key performance enablers of this SR engine are: high speech recognition accuracy, speaker-independent recognition, requires no user training, has a small, scalable footprint dependent on vocabulary requirements, supports unlimited-size dynamically loadable grammars, and supports statistical language models (SLM). This last feature is of importance since SLMs can be exploited to provide the broadest speech recognition dialog coverage. Optionally, if dialogs are written as finite state grammars, the UNIANCE compiler [Bos¹⁶] can be used to add a general semantic component to the Grammar Specification Language (GSL) before the grammar is compiled to a finite state machine needed for the language mode. In this way, the speech recognition engine can provide an output that is a syntactic or semantic representation of the student's utterance and be directly used with the dialog manager.
¹⁶Bos, J., Compilation of Unification Grammars with Compositional Semantics to Speech Recognition Packages, COLING 2002. Proceedings of the 19th International Conference on Computational Linguistics, 106-112. Taipei, Taiwan.

The research methodology and representative sub-tasks required to build and test the speech recognition interface and associated grammar development for the ITS are to:
Acquire speech recognition engine license from SRI.
Identify syntactical constructs of GSL and the elements in the ITS dialog design that drive the grammar.
Build statistical-based grammars so as to improve accuracy and compatibility with the dialog manager; Create statistical grammar models (SLM) using SRILM (publicly available from SRI) from a dialog training corpus.
Train SLM using SLM.EXE or other tools.
   Compare Speech Recognition and Sialog Performance Using Finite State and Statistical Language Models:
Build data sets for standalone speech recognition tests.
[The option of investigating the use of the UNIANCE compiler with the EduSpeak speech engine for providing a semantic output representation is not required in Phase I, but is a valuable option during Phase II when interfacing with the dialog manager.]
Write wrapper to transform engine to OAA agent.
Configure agent to be part of the community of OAA agents.
Once configured and debugged, carry out in-system tests to calculate sentence-level accuracy using the standard US NIST FOM metric: % Correct=H/N×100%, and the Accuracy=[H−I]/N×100% where H=# of correct labels, S=# of substitutions, I=# of insertions and N=# of Labels. Other speech recognition error metrics include: Sentence Error=H/N×100% where H is the number of sentences with totally correct transcriptions, or with totally correct semantic interpretations; and Word Error=[Insertion+Deletion+Substitutions/NumWords]×100%.
   Emotion Detector Agent

We will implement the algorithm of the emotional state detector developed in Objective 1 in C++ Software code. Within the scope of Objective 1, the functionality of this agent will be tested as a standalone unit, and assuming that the standalone implementation meets the specifications and technical requirements we will convert it to conform to an agent running within the OAA environment and proceed to integrate it with the speech recognition agent and the natural language agent.

Natural Language Agent

We will source the software for the CARMEL framework and follow the procedure to convert it to an OAA agent. Similarly, we will convert the CARMEL deep language understanding framework to a software agent running within the OAA environment.

The following describes the steps that will be followed as we assemble and run the community of OAA agents for speech recognition, emotion detection and natural language functions:

We expect that by fully achieving the goals in the objectives as described above, we will have laid a solid foundation going into Phase 2. The final task will be to develop a plan and road map for the full implementation of the architecture for an intelligent tutoring system having the specifications and requirements described in this proposal.

[image]

[image]

Part 5. Commercial Potential

The Problem

Demand for knowledge sharing and learning in the U.S. has increased due to several factors including:
Competition from an increasingly skilled global workforce.
Virtualization and outsourcing of highly skilled projects and services to more cost competitive—i.e. lower cost, human resources in areas outside the U.S.
Increased technological complexity in the workplace
Greater collaboration between businesses and their partners requires that increased knowledge and learning be brought to not only an internal audience but to external audiences as well.
The acceptance of e-Learning systems which have been effective in providing training but have not yet achieved the improvement in performance provided by human tutors.
A student can access the training at a time convenient to him/her.

There are some key problems that must be solved before computer-based learning systems are fully accepted and able to penetrate the training and tutoring market. The first and most important is to provide a more user friendly way to access this training and learning content. Currently most learning systems have content developed and deployed with very little interactivity. Speaktomi aims to enhance this user system interaction so as to be more intuitive for less experienced workers.

The Opportunity

Speaktomi's unique technology is critical to the next stage of e-Learning and computer based training tools. The leaders in the e-Learning provider market such as IBM, Docent, WBT and Saba Software are seeing increasing traction in this space mostly through their deployment of Learning Management Systems or LMS which store learning content. The next wave of innovation in the space is improving the process for the content creation and improving the ease and effectiveness of student interaction. The critical need to improve content is to provide the right kinds of tools for building learning environments that are easier to deploy and easier to use. Speaktomi's technology, by supporting voice interaction by the student with the e-Learning content, provides the critical ease of use platform that e-Learning tools developers need to make their systems more user-friendly and easier to interact with. As content creators are able to more intuitively gauge student understanding and concern through a voice interface, it will ease their conceptual workload in creating more engaging content that will not have to create exhaustive cases to gauge user feedback on content that has been presented.

Speaktomi's platform for improving user interaction will allow educational content tool developers such as Macromedia to offer a wider array of modes of interaction to content developers and reduce the cost of creating engaging content which is one of the major concerns in the emerging e-Learning space. Gartner¹⁹ has found that 74% of organizations that create content for e-Learning are spending a greater amount on content creation than before and 37% believe that the cost of delivering the content is greater than their traditional methods. Improvement in tools and effectiveness of e-Learning results are critical to continue to drive the market. Speaktomi will provide the core technology for human interaction to make this possible.
¹⁹“Academic E-Learning Must Confront Content Development Costs”, Gartner study April 2003

The Market

The e-Learning market is poised for explosive growth through 2005. The global e-Learning market was projected to grow to approximately $4.2 billion. By 2005, it will hit approximately $33.6 billion. e-Learning is still a relatively small part of the worldwide training market (estimated at more than $100 billion), but by the middle of this decade, it will make up almost one-third of all training deployed. Larger numbers of enterprises recognize that e-Learning is an obvious benefit in their technology infrastructure. Just as most e-mail projects were never cost justified, e-Learning will become a standard way of deploying knowledge transfer programs²⁰.
²⁰ “E-Learning in 2002: Growth, Mergers, Mainstream Adoption”, Gartner study December 2001

The realities of an explosive growth in e-Learning within companies has put more pressure on companies to provide content that is more accessible to a wider array of their staff members. Some 63 percent of all training in corporations from external providers (none e-Learning) is for new software applications that are critical for job functions. It is imperative that e-Learning tools and software developers provide a mechanism to allow better interaction with class participants. It is this market for improved tools and software that Speaktomi will seek to penetrate. Much as the current crop of speech recognition systems have been used as platforms for developing a broad array of customer service applications over the phone, Speaktomi will provide a platform to software and tools developers so that they have the technology to provide voiced-enabled learning for their e-Learning software products.

Speaktomi seeks not only to provide embedded technology to the corporate training software providers, but also to provide this technology for e-Learning for the U.S. education and training market eventually which had an overall market size of $772 billion in 2000 and a growth rate of over 9%. While speech technology may be considered a small component of a training solution, it is a critical user interface and interaction component that is extremely valuable. The size of this addressable market for Speaktomi is conservatively estimated to be $90 million. and $2.3 billion for the wider educational market. Clearly there is a substantial opportunity for a company focused on speech recognition and intelligent learning in both the corporate and wider educational e-Learning business.

The Product

The focus of our investigation is to implement an ITS architecture which addresses the issue of student understanding, so as to raise the level of performance by 1 to 2 standard deviation units. This level of tutorial performance would allow our system to be adopted by more users and to be used more effectively in the e-learning market. Additionally, by interfacing our system to Macromedia's widely-used authoring tools—Authorware and Director—our spoken language ITS will provide a direct and effective mechanism whereby the technology could be rapidly adopted by the existing educational customer base. Most importantly, this programming interface will allow legacy educational content to be accessed by the ITS; and in the future be extended to other commercial educational platforms and tools. The resulting benefits that would accrue include the features of an advanced intelligent training system that significantly raise the students' performance.

Competition

The market for e-Learning software is just evolving and is currently led by six major companies: Docent and Click2learn (now SumTotal), Saba Software, IBM, Pathlore and WBT systems. Other companies include Sun Microsystems, IBM, Siebel, SAP, PeopleSoft, KnowledgePlanet, THINQ, Plateau. Currently these providers have focused on the software for creating and managing learning content rather than featured technologies for improving the experience of students in a training environment. The main competitive thrust will come from companies already entrenched in the embedded speech technology for telephony. The leaders in this space are Nuance Communications, Speechworks/Scansoft and IBM and 5-10 others. It is quite likely that some of these companies will offer competitive voice-enabled e-Learning products. Clearly our proposed technology will substantially differentiate us in the tutoring and learning environments where the interactive process with students is extremely important. Also it is highly likely that these companies will also license our technology for deployment in telephony applications thus providing another channel for Speaktomi to sell products.

Business Model

The business model for marketing and selling Speaktomi's technology will be based on the following:
Focus on generating revenue through technology licensing
The development of an interface with Macromedia.
Start by winning customer acceptance and build market penetration within the existing corporate/education/eLearning markets.
Replicate strategy and build relationships with other key software vendors, schools, training institutions such as Kaplan, Educational Testing Service (ETS), Thomson and other training companies—key business strategy will be licensing.
Collaborate with key technical partners such as SRI International and CHI Systems to leverage advanced technology for driving the development of sophisticated interactive training systems.

Our focus on a license-based, embedded technology is important as our first point of entry. As the company grows, Speaktomi will focus on enhancing its relationship with content creators and providing services to these creators so that they may better use speech technologies in their learning/tutoring applications. In the long run, Speaktomi intends to maintain core competence in automated speech learning environment providing core technology, consulting services and eventually outsource speech-enabled courseware development. The initial plan for Speaktomi is to work with e-Learning educational authoring tools providers to integrate its technology into their platforms. License revenue will be focused on between 2-5% of the ASP of the finished product or tool—client based tools and support, and server-based products for the corporate environment with competitive pricing.

### A.8.4. REFERENCES CITED AND INCORPORATED BY REFERENCE

American Society for Trainers and Development (ASTD), A Vision for E-Learning for America's Workforce, referencing Moe, Michael, and Henry Blodgett, The Knowledge Web, Merrill Lynch & Co., Global Securities Research & Economics Group, 2000.
Ang J., Dhillon R., Krupski A., Shriberg E., and Stolcke A., Prosody-Based Automatic Detection of Annoyance and Frustration in Human-Computer Dialog, ICSLP-2002, Denver, Colo., USA, September 2002
Ang J., Prosodic Cues For Emotion Recognition In Communicator Dialogs, M.S. Thesis, University of California at Berkeley, December 2002.
Bahl, L. R., Jeninek, F., Mercer, R. L., A maximum likelihood approach to continuous speech recognition, IEEE Trans. Pattern Anal. Mach. Intell., PAMI-5: 179-190, 1983.
Baker, Collin F., Fillmore, Charles J., and Lowe, John B. (1998): The Berkeley FrameNet project. In Proceedings of the COLING-ACL, Montreal, Canada.
Baker, J. H., The Dragon system—An Overview, IEEE Trans. on ASSP Proc. ASSP-23(1): 24-29, February 1975.
Baum L. E., An inequality and associated maximization technique in statistical estimation for probabilistic functions of Markov processes, Inequalities 3: 1- 8, 1972.
Baum, L. E., Petrie, T., Statistical inference for probabilistic functions for finite state Markov chains, Ann. Math. Stat., 37: 1554-1563, 1966.
Bennett, C. et al, Building VoiceXML-based Applications, ICSLP-2002 Proceedings, 7th International Conference On Spoken Language Processing, September 2002, Denver, Colo., USA.
Bennett, C., Font Llitjos, A., Shriver, S., Rudnicky, A., Black, A., Building VoiceXML-Based Applications, 7th International Conference On Spoken Language Processing, September 2002, Denver, Colo., USA.
Boyce, S. (2000). Natural Spoken Dialogue Systems for Telephony Applications. Communications of the ACM., Vol. 43, No. 9, pp. 29-34.
Business Week On-line, Web Training Explodes, May 22, 2000
Chi, M. T. H., Slofta, J. D., & de Leeuw, N. (1994). From things to processes: A theory of conceptual change for learning science concepts, Learning and Instruction, 4, 27-43.
Classroom Lessons: Integrating Cognitive Theory and Classroom Practice (pp. 51-74). Cambridge: MIT
Collins M., Three generative, lexicalised models for statistical parsing. In Proceedings of the 35th Annual Meeting of the Association for Computational Linguistics, Madrid, Spain, July 1997.
de Kleer, J. & Brown, J. S. (1984), A qualititative physics based on confluences, Artificial Intelligence, 24, 7-83.
Docio-Ferandez, L., Garcia-Mateo, C., Distributed Speech Recognition Over IP Networks on the Aurora 3 Database, ICSLP-2002 Proceedings, 7th International Conference On Spoken Language Processing, September 2002, Denver, Colo., USA.
Education, 1, 205-221.
Ferandez and Garcia-Mateo, Distributed Speech Recognition over IP networks on the Aurora 3 Database, ICSLP-2002 Proceedings, Denver, Colo., USA.
Ferguson, J. D., Hidden Markov Analysis: An Introduction, in Hidden Markov Models for Speech, Institute of Defense Analyses, Princeton, N.J. 1980.
Fillmore, C. J. 1971. ‘Some problems for case grammar’. In: O'Brien, R. J. (ed.) Report of the 22nd Annual Round Table Meeting on Linguistics and Language Studies. Washington: Georgetown UP. 35-56.
Fillmore, Charles J. (1976): Frame semantics and the nature of language; Annals of the New York Academy of Sciences: Conference on the Origin and Development of Language and Speech, Volume 280 (pp. 20-32).
Finscheidt, T., Aalburg, S., Stan, S., Beaugeant, C., Network-Based vs.Distributed Speech Recognition in Adaptive Multi-Rate Wireless Systems, ICSLP-2002 Proceedings, 7th International Conference On Spoken Language Processing, September 2002, Denver, Colo., USA.
Forbes, Master of the Knowledge Universe, Sep. 10, 2001
Forbes, Special E-Learning Section, referencing Corporate E-Learning: Exploring a New Frontier by Hambrecht, W.R. & Company, March 2000.
FrameNet: Theory and Practice. Christopher R. Johnson et al, http://www.icsi.berkeley.edu/˜framenet/book/book.html
FRG: Institute for Science Education.
Gildea D and Jurafsky D., 2002. Automatic Labeling of Semantic Roles. Computational Linguistics 28:3, 245-288.
Graesser, A., Wiemer-Hastings, K., Wiemer-Hastings, P., Kreuz, R., & the Tutoring Research Group (2000). AutoTutor: A simulation of a human tutor, Journal of Cognitive Systems Research, 1,35-51.
Grosz, B., and Sidner, C., Attention, intention and the structure of discourse, Computational Linguistics, 12(3), 1986.
Guinn, C., & Montoya, R. (1997), Natural Language Processing in Virtual Reality Training Environments, Proceedings of the 19th Interservice/Industry Training Systems and Education Conference (I/ITSEC '97), Orlando, Fla.
Guinn, C., & Montoya, R. (1997). Natural Language Processing in Virtual Reality Training Environments, Proceedings of the 19th Interservice/Industry Training Systems and Education Conference (I/ITSEC '97), Orlando, Fla.
Hake, R. R. (under review), Interactive-engagement vs. traditional methods: A six-thousand student survey of mechanics test data for introductory physics courses.
Halloun, I. A. & Hestenes, D. (1985), Common sense concepts about motion, American Journal of Physics, 53(11), 1056-1065.
Hambrecht, W. R. & Company, A Vision for E-Learning for America's Workforce, American Society for Trainers and Development (ASTD), referencing Corporate E-Learning: Exploring a New Frontier, 2000.
Henton, C. (2002), Fiction and reality of TTS, Speech Technology Magazine, January-February, pp. 36-39.
Hestenes, D., Wells, M., & Swackhamer, G. (1992), Force concept inventory, Physics Teacher, 30, 141—
Holzmann, G. J., Design and Validation of Computer Protocols, Prentice Hall, New Jersey, 1991, ISBN 0-13-539925-4.
Hunt, E. & Minstrell, J. (1994), A cognitive approach to the teaching of physics, In K. McGilly (Ed.), In K. McGilly (Ed.), Classroom Lessons: Integrating Cognitive Theory and Classroom Practice (pp. 51-74). Cambridge: MIT Press.
Jeninek, F., et al, Continuous Speech Recognition: Statistical methods in Handbook of Statistics, II, P. R. Kristnaiad, Ed. Amsterdam, The Netherlands, North-Holland, 1982.
Johnston, M., Bangalore, S., Stent, A., Vasireddy, G., Ehlen, P., Multimodal Language Processing for Mobile Information Access, ICSLP-2002 Proceedings, 7th International Conference On Spoken Language Processing, September 2002, Denver, Colo., USA.
Jordan, P. , Makatchev, M., and VanLehn, K., 2003. Abductive Theorem Proving for Analyzing Student Explanations. In Proceedings of Artificial Intelligence in Education Conference.
Karat, C., Halverson, C., and Karat, J. (1999), Patterns of Entry and Correction in Large Vocabulary Continuous Speech Recognition Systems. Proceedings of CHI'99: Human Factors in Computing Systems, New York, N.Y., May 15-20, pp. 568-575.
Lea, W. A. (ed.), Trends in speech recognition, Englewood Cliffs, N.J., Prentice Hall, 1980.
Litman D. and Forbes-Riley K., Predicting Student Emotions in Computer-Human Tutoring Dialogues. In Proceedings of the 42nd Annual Meeting of the Association for Computational Linguistics (ACL), Barcelona, Spain, July 2004.
Litman D. and Silliman S., ITSPOKE: An Intelligent Tutoring Spoken Dialogue System. In Proceedings of the Human Language Technology Conference: 4th Meeting of the North American Chapter of the Association for Computational Linguistics (HLT/NAACL) (Companion Proceedings), Boston, Mass., May 2004.
Litman D., and Forbes K., Recognizing Emotions from Student Speech in Tutoring Dialogues. In Proceedings of the IEEE Automatic Speech Recognition and Understanding Workshop (ASRU), St. Thomas, Virgin Islands, November-December, 2003
Litman, D., and Allen, J. F., A plan recognition model for sub dialogues in conversation, Cognitive Science, 11(2): 163-200.
Macho, D., et al, Evaluation of a Noise-Robust DSR Front-End on Aurora Databases, ICSLP-2002 Proceedings, 7th International Conference On Spoken Language Processing, Sept. 2002, Denver, Colo., USA.
Maeireizo B., Litman D., and Hwa R., Co-training for Predicting Emotions with Spoken Dialogue Data. In Companion Proceedings of the 42nd Annual Meeting of the Association for Computational Linguistics (ACL), Barcelona, Spain, July 2004
Martinovic, Miroslav (2002) Integrating statistical and linguistic approaches in building intelligent question answering systems. A presentation at the International Conference on Advances in Infrastructure for 3-busines, e-Education, e-Science, and e-Medicine on the Internet, SSGRR 2002W
Mazur, E. (1993). Peer Instruction: A User's Manual, Cambridge, Mass.: Harvard University Press
McCloskey, M., Caramazza, A., & Green, B. (1980), Curvilinear motion in the absence of external forces: Naive beliefs about the motion of objects. Science, 210(5), 1139-1141
Meng, H., et al, ISIS: A Multi-Modal, Trilingual, Distributed Spoken Dialog System developed with CORBA, Java, XML and KQML, ICSLP 2002 Proceedings, Denver, Colo., USA.
Mindlever.com, Market Trends and E-Learning, a white paper referencing IDC.
Morgan, N., Bourlard, H., Renals, S., Cohen, M., and Franco, H., (1993), Hybrid Neural Network/Hidden Markov Model Systems for Continuous Speech Recognition, Journal of Pattern Recognition and Artificial Intelligence, Vol. 7, No. 4 pp. 899-916.
Ortiz, C. L. and Grosz, B., Interpreting Information Requests in Context: A Collaborative Web Interface for Distance Learning. To appear, Autonomous Agents and Multi-Agent Systems, 2002.
Pfundt, H. & Duit, R. (1991). Bibliography: Students' Alternative Frameworks and Science Education, Kiel,
Ploetzner, R. & VanLehn, K. (1997). The acquisition of informal physics knowledge during formal physics
Poison, M., & Richardson, J. (Eds.) (1988). Foundations of intelligent tutoring systems. Hillsdale, N.J.: Erlbaum Press.
Profit Magazine, The E-Learning Curve, referencing Information Week, quoting IDC and W.R. Hambrecht, May 2001
Rabiner, H. R., and Juang, B. H., Fundamentals of Speech Recognition, Prentice Hall, 1993.
Rabiner, H. R., Digital Processing of Speech Signals, Prentice Hall, 1978.
Rosé C., Litman D., Bhembe D., Silliman S., Srivastava R., and Van Lehn K., A Comparison of Tutor and Student Behavior in Speech versus Text-Based Tutoring, Proceedings of the HLT/NAACL Workshop: Building Educational Applications Using NLP, June, 2003.
Ryder, J, Santarelli, T, Scolaro, J., Hicinbothom, J., & Zachary, W. (2000). Comparison of cognitive model uses in intelligent training systems. In Proceedings of IEA2000/HFES2000 (pp. 2-374 to 2-377). Santa Monica, Calif.: Human Factors Society.
Ryder, J. M., Graesser, A. C., McNamara, J., Karnavat, A., & Popp, E. (2002). A dialog-based intelligent tutoring system for practicing command reasoning skills. Proceedings of the 2002 Interservice/Industry Training Simulation, and Education Conference [CD-ROM]. Arlington, Va.: National Defense Industrial Association.
SALT Forum at: http://www.saltforum.org
Shneiderman, B. (2000), The Limits of Speech Recognition. Communications of the ACM., Vol. 43, No. 9, pp. 63-65.
Shriberg E. and Stolcke A., Direct Modeling of Prosody: An Overview of Applications in Automatic Speech Processing, Proc. International Conference on Speech Prosody, Nara, Japan, March 2004
Shriberg E., Stolcke A., Prosody Modeling for Automatic Speech Recognition and Understanding, Mathematical Foundations of Speech and Language Modeling, M. Johnson, M. Ostendorf, S. Khudanpur, R. Rosenfeld (eds.), Volume 138 in IMA Volumes in Mathematics and its Applications, pp. 105-114, Springer-Verlag.
Shute, V. J., & Psotka, J. (1995). Intelligent tutoring systems: Past, present, and future. In D. Janassen (Ed.), Handbook of Research on Educational Communications and Technology, Scholastic Publications.
Slotta, J. D., Chi, M. T. H., & Joram, E. (1995), Assessing students' misclassifications of physics concepts: An ontological basis for conceptual change, Cognition and Instruction, 13(3), 373-400.
Smith, J. P., diSessa, A. A., & Roschelle, J. (1993), Misconceptions reconceived: A constructivist analysis of knowledge in transition, Journal of the Learning Sciences, 2(2), 115-164.
Speech technology and natural language research at the Microsoft Corp. Redmond and Shanghai Research Laboratories applied to the Pocket PC, MiPad and other mobile appliances, see http://www.microsoft.com/research/speech
Steven Abney, Partial Parsing via Finite-State Cascades. J. of Natural Language Engineering, 2(4): 337-344. 1996.
The VoiceXML Forum at http://www.voicexml.org
Thomas K. Landauer, Peter W. Foltz, and Darrell Laham. An introduction to latent semantic analysis,.Discourse Processes, 25:259-284, 1998.
Training, Cognition and Instruction, 15(2), 169-206.
Tversky, A. & Kahneman, D. (1974), Judgments under uncertainty: Heuristics and biases, Science, 185,
U.S. Bancorp Piper Jaffray, 20001
Van Valin R. (ed.). 1993. Advances in role and reference grammar. Amsterdam John Benjamins.P166 A34
Viennot, L. (1979), Spontaneous reasoning in elementary dynamics, European Journal of Science
Walker, M., et al., DARPA Communicator Evaluation: Progress from 2000 to 2001, ICSLP-2002 Proceedings, 7th International Conference On Spoken Language Processing, September 2002, Denver, Colo., USA.
Walker, M., et al., DARPA Communicator: Cross-System Results for the 2001 Evaluation, ICSLP-2002 Proceedings, 7th International Conference On Spoken Language Processing, Sept. 2002, Denver, Colo., USA.
Wang, K., SALT: A Spoken Language Interface for Web-Based Multimodal Dialog Systems, 7th International Conference On Spoken Language Processing, September 2002, Denver, Colo., USA.
Weld, D. & de Kleer, J. (1990), Readings in Qualitative Reasoning about Physical Systems, Menlo Park, Calif.: Morgan Kaufmann.
Wenger, E. (1987). Artificial intelligence and tutoring systems, Los Altos, Morgan Kaufmann, 1987.
WordNet, A Lexical Database for English. Cognitive Science Laboratory, Princeton University. http://www.cogsci.princeton.edu/˜wn/.
Young, S. J., and C E Proctor, C. E., The design and implementation of dialogue control in voice operated database inquiry systems, Computer Speech and Language, vol. 3, no. 4, pp. 329-353,1989.
Zachary, W. Santarelli, T., Lyons, D., Bergondy, M. and Johnston, J. (2001). Using a Community of Intelligent Synthetic Entities to Support Operational Team Training. In Proceedings of the Tenth Conference on Computer Generated Forces and Behavioral Representation. Orlando: Institute for Simulation and Training.
Zachary, W., Le Mentec, J-C., & Ryder, J. (1996). Interface agents in complex systems. In C. Ntuen & E. H. Park (Eds.), Human interaction with complex systems: Conceptual Principles and Design Practice. Norwell, Mass.: Kluwer Academic Publishers.
Zachary, W. W., Ryder, J. M., & Hicinbothom, J. H. (2000). Building cognitive task analyses and models of a decision-making team in a complex real-time environment. In J. M. Schraagen, S. F. Chipman, & V. L. Shalin (Eds.), Cognitive Task Analysis. Mahwah, N.J.: Erlbaum.
Zachary, W. W., Ryder, J. M., Ross, L., & Weiland, M. Z. (1992). Intelligent computer-human interaction in real-time multi-tasking process control and monitoring systems. In M. Helander and M. Nagamachi (Eds.), Design for Manufacturability. New York: Taylor and Francis.
Zue, V., Seneff, S., Glass, J. R., Polifroni, J., Pao, C., Hazen, T. J., and Hetherington, L., Jupiter: A telephone-based conversational interface for weather information, IEEE Trans Acoustics, Speech and Signal Processing, vol. 8, no. 1, pp. 85-96, 2000.

While the preferred embodiment is directed specifically to integrating the prosody analyzer with embodiments of a NLQS system of the type noted above, it will be understood that it could be incorporated within a variety of statistical based NLQS systems. Furthermore, the present invention can be used in both shallow and deep type semantic processing systems of the type noted in the incorporated patents. The microcode and software routines executed to effectuate the inventive methods may be embodied in various forms, including in a permanent magnetic media, a non-volatile ROM, a CD-ROM, or any other suitable machine-readable format. Accordingly, it is intended that all such alterations and modifications be included within the scope and spirit of the invention as defined by the following claims.

What is claimed is:

1. In a method for performing real-time speech recognition distributed across a client device: and a server device, and which transfers speech data from an utterance to be recognized using a packet stream of extracted acoustic feature data including at least some cepstral coefficients, the improvement comprising:
extracting prosodic features from the utterance to generate extracted prosodic data; transferring said extracted prosodic data with said extracted acoustic feature data to the server device;
recognizing an emotion state of a speaker of the utterance based on at least said extracted prosodic data;
wherein operations associated with recognition of prosodic features in the utterance are also distributed across the client device and server device.

2. The method of claim 1, wherein said operations are distributed across the client device and server device on a case-by-case basis.

3. The method of claim 1 further including a parts-of-speech analyzer for identifying a first set of emotion cues based on evaluating a syntax structure of the utterance.

4. The method of claim 1 further including a real-time classifier for identifying the emotion state based on said first set of emotion cues and a second set of emotion cues derived from said extracted prosodic data.

5. The method of claim 1, wherein said prosodic features include data values which are related to one or more acoustic measures including one of PITCH, DURATION & ENERGY.

6. The method of claim 1, wherein said emotion state includes at least one of STRESS & NON-STRESS.

7. The method of claim 1, wherein said emotion state includes at least one of CERTAINTY, UNCERTAINTY and/or DOUBT.

8. A method for performing real-time emotion detection comprising:
extracting selected acoustic features of a speech utterance;
extracting syntactic cues relating to an emotion state of a speaker of said speech utterance;
classifying inputs from said prosody analyzer and said parts-of-speech analyzer and processing the same to output an emotion cue data value corresponding to said emotion state.

9. A method for training a real-time emotion detector comprising:
presenting a series of questions to a first group of persons concerning a first topic;
wherein said questions are configured to elicit a plurality of distinct emotion states from said first group of persons;
recording a set of responses from said first group of persons to said series of questions;
annotating said set of responses to include a corresponding emotion state;
training an emotion modeler based on said set of responses and corresponding emotion state annotations;
wherein said emotion modeler is adapted to be used in an emotion detector distributed between a client device and a server device.

10. The method of claim 9, wherein visual cues are also used to elicit said distinct emotion states.

11. The method of claim 9, wherein said annotations are derived from Kappa statistics associated with a second group of reviewers.

12. The method of claim 9, further including a step: transferring said emotion modeler in electronic form to a client device or a server device.

13. The method of claim 9 further including a step: determining an emotion state of a speaker of an utterance based on said emotion modeler.

14. A real-time emotion detector system comprising:
a prosody analyzer adapted to extract selected acoustic features of a speech utterance;
a parts-of-speech analyzer adapted to extract syntactic cues relating to an emotion state of a speaker of said speech utterance;
a classifier adapted to receive inputs from said prosody analyzer and said parts-of-speech analyzer and process the same to output an emotion cue data value corresponding to said emotion state.

15. The system of claim 14 wherein the classifier is a trained Classification and Regression Tree classifier.

16. The system of claim 14 wherein said classifier is trained with data obtained during an off-line training phase.

17. The system of claim 16 wherein said classifier uses a history file containing data values for emotion cues derived from a sample population of test subjects and using a set of sample utterances common to content associated with the real-time recognition system.

18. The system of claim 14 wherein said emotion cue data value is in the form of a data variable suitable for inclusion within a SQL construct.

19. In a system for performing real-time speech recognition which is distributed across a client device and a server device, and which transfers speech data from an utterance to be recognized using a packet stream of extracted acoustic feature data including at least some cepstral coefficients, the improvement comprising:
a first routine executing on the client device configured to extract prosodic features from the utterance and to generate extracted prosodic data;
a second routine executing on the client device configured to transfer said extracted prosodic data with said extracted acoustic feature data to the server device;
a third routine executing on the server device configured to recognize an emotion state of a speaker of the utterance based on at least said extracted prosodic data;
wherein operations associated with recognition of prosodic features in the utterance are also distributed across the client device and server device.

20. The system of claim 19 further including a fourth routine executing on the server device configured to extract syntax information from the utterance and generate a set of emotion cues which are used by said third routine in combination with said extracted prosodic data to determine said emotion state.

21. The system of claim 19, wherein said emotion state is used to formulate a response by an interactive agent in a real-time natural language processing system.

22. The system of claim 19, wherein said emotion state is used by an interactive agent to control dialog content and/or a dialog sequence with a user of a speech recognition system.

23. The system of claim 19 wherein said emotion state is used to control visual feedback presented to a user of the real-time speech recognition system.

24. The system of claim 19 wherein said emotion state is used to control non-verbal audio feedback presented to a user of the real-time speech recognition system.

25. The system of claim 24 wherein said non-verbal audio feedback is one of a selected set of audio recordings associated with different user emotion states.

26. The system of claim 19, wherein an amount of prosodic data to be transferred to said server device is determined on a case by case basis in accordance with one or more of the following parameters: a) computational capabilities of the respective devices; b) communications capability of a network coupling the respective devices; c) loading of said server device; d) a performance requirement of a speech recognition task associated with a user query.

27. The system of claim 19, wherein both prosodic data and acoustic feature data are packaged within a common data stream as received at the server device.

28. The system of claim 19, wherein prosodic data and acoustic feature data are packaged within different data streams as received at the server device.

29. The system of claim 19, wherein said prosodic data and acoustic feature data are transmitted using different priorities.

30. The system of claim 29, wherein said prosodic data is transmitted with a higher priority than said acoustic feature data.

31. The system of claim 30, wherein said prosodic data is selected and configured to have a data content which is significantly less than said acoustic feature data.

32. The system of claim 19, wherein said prosodic data and acoustic feature data are configured with different payload formats within their respective packets by a transport routine.

33. The system of claim 19, wherein said emotion state is determined by evaluating both individual words and an entire sentence of words uttered by the user.

34. The system of claim 19, further including a calibration routine.
